(19) United States
(12) Patent Application Publication
(10) Pub. No.: US 2020/0175890 A1
(43) Pub. Date: Jun. 4, 2020

(54) DEVICE, METHOD, AND GRAPHICAL USER INTERFACE FOR A GROUP READING ENVIRONMENT

(71) Applicant: Apple Inc., Cupertino, CA (US)

(72) Inventors: Michael I. INGRASSIA, San Jose, CA (US); Richard M. POWELL, Mountain View, CA (US); David SHOEMAKER, Redwood City, CA (US); Casey M. DOUGHERTY, San Francisco, CA (US); Gregory S. ROBBIN, Mountain View, CA (US)

(21) Appl. No.: 16/785,357

(22) Filed: Feb. 7, 2020

Related U.S. Application Data
(63) Continuation of application No. 14/210,386, filed on Mar. 13, 2014.
(60) Provisional application No. 61/785,361, filed on Mar. 14, 2013.

(51) Int. Cl. G09B 17/00

(52) U.S. Cl. CPC G09B 17/003

(57) ABSTRACT

The method includes receiving selection of text to be read in a group reading session; identifying a plurality of participants for the group reading session; and upon receiving the selection of the text and the identification of the plurality of participants, automatically, without user intervention, generating a reading plan for the group reading session, wherein the reading plan divides the text into a plurality of reading units and assigns at least one reading unit to each of the plurality of participants in accordance with a comparison between a respective difficulty level of the at least one reading unit and a respective reading ability level of the participant.

### CROSS REFERENCE TO RELATED APPLICATIONS

This present application claims priority to U.S. Provisional Application Ser. No. 61/785,361, filed Mar. 14, 2013, which is incorporated by reference herein in its entirety.

### TECHNICAL FIELD

This relates generally to electronic devices, including but not limited to electronic devices with speech-to-text (STT) processing capabilities.

### BACKGROUND

Computers and other electronic devices are become an increasingly important tool in education today. Electronic versions of reading materials, such as textbooks, articles, compositions, stories, reading assignments, lecture notes, etc., are frequently used in class for reading and discussion purposes. Some electronic reading devices display reading materials in a way that gives the electronic reading material the look and feel of a real paper book (e.g., an eBook with “flip-able” pages). Some electronic reading devices also provide additional functionalities that allow the reader to interact with the reading materials, such as marking and annotating the reading materials electronically. Some electronic reading devices have text-to-speech (TTS) functionalities that can “speak” the text of the reading materials aloud to the user. Sometimes, a child can have a story read to him or her by an electronic reading device that has text-to-speech (TTS) capabilities.

Conventional electronic reading devices are suitable for readers that are capable of and/or prefer to read independently of others. However, in some environment, collaborative or group reading may be more beneficial to a reader than solo reading by the reader alone. For example, in a classroom environment, a group of children may participate in collaborative reading of a single story, with each child reading only a portion of the whole story. In another example, in a home, a parent may read part of a story to a child, while allowing the child to participate in reading the remainder of the story. Existing electronic reading devices are inadequate in providing an easy, intuitive, fun, interactive, versatile, and/or educational way of organizing the group or collaborative reading of multiple readers in the same group reading session.

### SUMMARY

Accordingly, there is a need for electronic devices with faster, more intuitive, and more efficient methods and interfaces for facilitating collaborative reading in a group reading environment. Such methods and interfaces may complement or replace conventional methods for displaying electronic reading materials on user devices. Such devices, methods, and interfaces increase the efficiencies, organization, and interactivity of the group reading session, and enhance the learning experience and enjoyment of the users during group reading.

In some embodiments, the device is a desktop computer. In some embodiments, the device is a portable computing device (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the user interacts with the device primarily through a voice interface.

In some embodiments, the functions provided by the device optionally include one or more of designing a group reading plan, establishing a collaborative reading group comprising multiple user devices, handing off reading control to another device, taking over reading control from another device, displaying reading prompts, providing reading aids, evaluating reading quality, providing annotation tools, generating additional reading exercises, changing the plot and/or other aspects of the reading material, displaying reading material and graphical illustrations associated with the reading materials, and so on. Executable instructions for performing these functions are optionally included in a non-transitory computer readable storage medium or other computer program product configured for execution by one or more processors.

In accordance with some embodiments, a method is performed at an electronic device having one or more processors, memory, and a display. The method includes receiving a selection of text to be read in a group reading session; identifying a plurality of participants for the group reading session; and upon receiving the selection of the text and the identification of the plurality of participants, automatically, without user intervention, generating a reading plan for the group reading session, wherein the reading plan divides the text into a plurality of reading units and assigns at least one reading unit to each of the plurality of participants in accordance with a comparison between a respective difficulty level of the at least one reading unit and a respective reading ability level of the participant.

In accordance with some embodiments, a method is performed at a first client device associated with a first user, the first client device having one or more processors and memory. The method includes: registering with a server of the group reading session to participate in the group reading session; upon successful registration, receiving at least a partial reading plan from the server, the partial reading plan divides text to be read in the reading session into a plurality of reading units and assigns at least a first reading unit of a pair of consecutive reading units to the first user, and a second reading unit of the pair of consecutive reading units to a second user; upon receiving a first start signal for the reading of the first reading unit, displaying a first reading prompt at a respective start location of the first reading unit currently displayed at the first client device; monitoring progress of the reading of the first reading unit based on a speech signal received from the first user; in response to detecting that the reading of the first reading unit has been completed: ceasing to display the first reading prompt at the first client device; and sending a second start signal to a second client device associated with the second user, the second start signal causing a second reading prompt to be displayed at a respective start location of the second reading unit currently displayed at the second client device.

In accordance with some embodiments, a method is performed at a device having one or more processors, memory, and a display. The method includes: receiving a first reading assignment comprising text to be read or recited aloud by a user; receiving a first speech signal from the user reading or reciting the text of the first reading assignment; evaluating the first speech signal against the text to identify one or more areas for improvement; and based on the evaluating, generating a second reading assignment providing additional practice opportunities tailored to the identified one or more areas for improvement.

In accordance with some embodiments, a method is performed at a first device having one or more processors, memory, and a display. The method includes: displaying text of a first segment of a multi-segment textual document on the first device, the text including one or more keywords each associated with a respective portion of a first graphical illustration for the first segment of the multi-segment textual document; detecting a first speech signal reading the first segment of the multi-segment textual document; upon detecting each of the one or more keywords in the first speech signal, sending a respective first illustration signal to a second device, wherein the respective first illustration signal causes the respective portion of the graphical illustration associated with the keyword to be displayed on the second device.

The embodiments described in this specification may realize one or more of the following advantages. In some embodiments, text for reading in a group reading session is automatically divided and assigned to the anticipated participants of the group reading session. The text division and assignment are customized based on the difficulty of the text and the reading ability of the participants. The instructor of the group reading session optionally select different assignment modes (e.g., challenge mode, encouragement mode, and reinforcement mode) based on the particular temperament and performance of individual students, making the automatic division and assignment of the reading units more suited for the real teaching environment. During a group reading session, reading prompt is automatically provided on particular user's devices, saving valuable class time from being wasted on picking a student to participate in the reading. In addition, reading prompt is only displayed on a particular student's when it is that student's turn to read, saving valuable class time from being wasted on the student looking for the correct section to read when he or she is called on. Various visual aids and real-time feedback is provided to both the listening participant and the reading participant of the group reading session. Customized reading assignment is automatically generated for each student, such that they can practice the weaker points identified during the group reading. Each individual device can partially take over the teacher's role to evaluate the student's performance in completing the customized reading assignment, saving the instructor valuable time. Various study aids and annotation tools can be provided to the user during the user's completion of the customized homework assignment. The embodiments described in this specification can be used in many settings outside of the classroom or school environment as well. In professional and private sessions, the embodiments described in this specification provide better learning experience, and allow the user to better enjoy reading on an electronic device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an exemplary multifunction device in accordance with some embodiments.

FIG. 2 is a block diagram of an exemplary portable multifunction device in accordance with some embodiments.

FIG. 3 is a block diagram illustrating an exemplary multifunction device in accordance with some embodiments.

FIGS. 4A-4F is a flow chart for an exemplary process for generating a group reading plan and facilitating a group reading session based on the reading plan in accordance with some embodiments.

FIGS. 5A-5B illustrate exemplary user interfaces for generating and reviewing a group reading plan in accordance with some embodiments.

FIGS. 6A-6B illustrate exemplary processes for transferring reading control in a group reading session in accordance with some embodiments.

FIGS. 7A-7D is a flow chart for an exemplary method of transferring reading control in a group reading session in accordance with some embodiments.

FIGS. 8A-8B is a flow chart for an exemplary method of generating a customized reading assignment for a user in accordance with some embodiments.

FIGS. 9A-9B is a flow chart for an exemplary method of facilitating collaborative story reading in accordance with some embodiments.

FIGS. 10A-10H illustrate exemplary user interfaces and processes used in a collaborative story reading session in accordance with some embodiments.

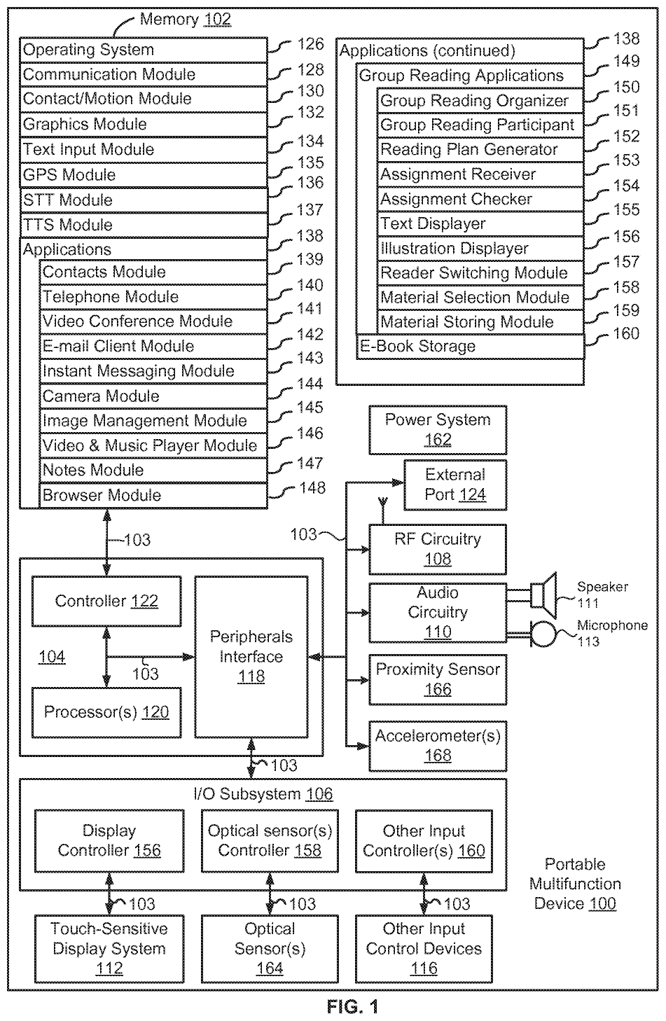

For a better understanding of the aforementioned embodiments of the invention as well as additional embodiments thereof, reference should be made to the Description of Embodiments below, in conjunction with the drawings in which like reference numerals refer to corresponding parts throughout the FIGS. 1-10H.

### DESCRIPTION OF EMBODIMENTS

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), may also be used. It should also be understood that, in some embodiments, the device is not a portable communications device, but is a desktop computer with a touch-sensitive surface (e.g., a touch screen display and/or a touch pad).

In the discussion that follows, an electronic device that includes a display (e.g., a touch-sensitive display screen) is described. It should be understood, however, that the electronic device may include one or more other physical user-interface devices, such as a physical keyboard, a mouse and/or a joystick.

The device typically supports a variety of applications, such as one or more of the following: a drawing application, a presentation application, a word processing application, a spreadsheet application, a gaming application, a telephone application, a video conferencing application, an e-mail application, an instant messaging application, a photo management application, a digital camera application, a digital video camera application, a web browsing application, a digital music player application, and/or a digital video player application. The device particularly supports an application, such as an eBook reader application, a Portable Document Format (PDF) reader application, and other electronic book reader applications, that is capable of displaying an electronic textual document in one or more formats (e.g., *.txt, *.pdf, *.rar, *.zip, *.tar, *.aeh, *.html, *.djvu, *.epub, *.pdb, *.fb2, *.xeb, *.ceb, *.ibooks, *.exe, BBeB, and so on). In some embodiments, the device also support display of one or more graphical illustrations, animations, sounds, and widgets associated with the electronic textual document.

Attention is now directed toward embodiments of portable devices with touch-sensitive displays. FIG. 1 is a block diagram illustrating portable multifunction device 100 with touch-sensitive displays 112 in accordance with some embodiments. Touch-sensitive display 112 is sometimes called a “touch screen” for convenience, and may also be known as or called a touch-sensitive display system. Device 100 optionally includes memory 102 (which may include one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. These components, optionally, communicate over one or more communication buses or signal lines 103.

It should be appreciated that device 100 is only one example of a portable multifunction device, and that device 100 may have more or fewer components than shown, may combine two or more components, or may have a different configuration or arrangement of the components. The various components shown in FIG. 1 may be implemented in hardware, software, or a combination of both hardware and software, including one or more signal processing and/or application specific integrated circuits.

Memory 102 optionally includes high-speed random access memory and/or non-volatile memory, such as one or more magnetic disk storage devices, flash memory devices, or other non-volatile solid-state memory devices. Access to memory 102 by other components of device 100, such as CPU 120 and the peripherals interface 118, is optionally controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are optionally implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108, optionally, includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11 n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol.

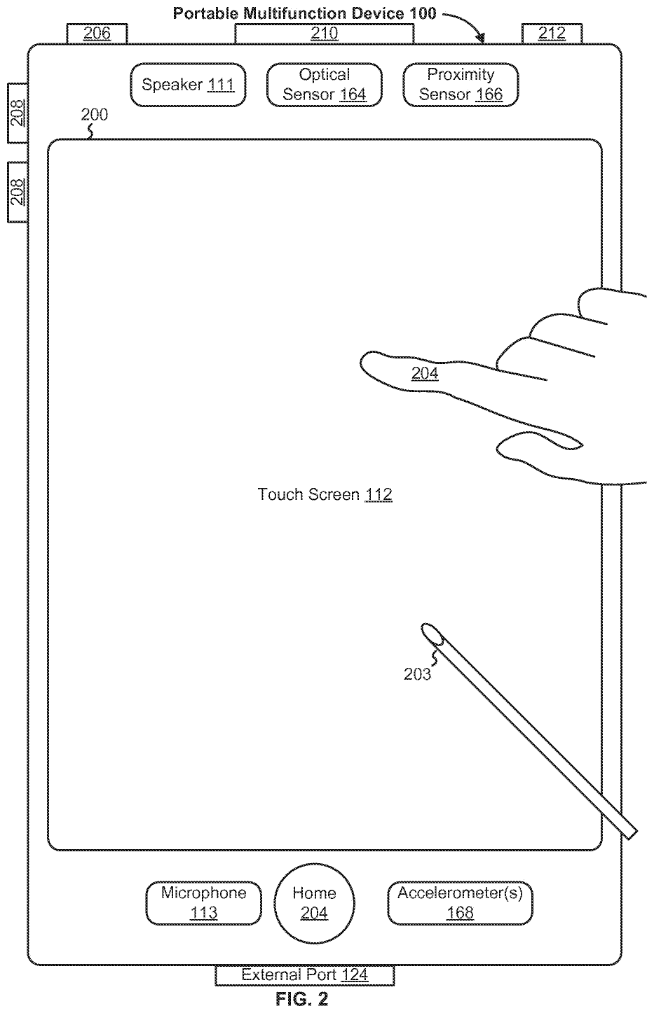

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is optionally retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156 and one or more input controllers 160 for other input or control devices. The one or more input controllers 160 receive/send electrical signals from/to other input or control devices 116. The other input control devices 116 optionally includes physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of speaker 111 and/or microphone 113. The one or more buttons may include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1 shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, another optical sensor is located on the front of the device so that the user's image may be obtained for videoconferencing while the user views the other video conference participants on the touch screen display.

Device 100 may also include one or more proximity sensors 166. FIG. 1 shows proximity sensor 166 coupled to peripherals interface 118. Alternately, proximity sensor 166 may be coupled to input controller 160 in I/O subsystem 106. In some embodiments, the proximity sensor turns off and disables touch screen 112 when the multifunction device is placed near the user's ear (e.g., when the user is making a phone call).

Device 100 may also include one or more accelerometers 168. FIG. 1 shows accelerometer 168 coupled to peripherals interface 118. Alternately, accelerometer 168 may be coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, speech-to-text (STT) module 136 (or set of instructions), text-to-speech (TTS) module (or set of instructions) 137, and applications (or sets of instructions) 138.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 may detect contact with touch screen 112 (in conjunction with display controller 156) and other touch sensitive devices (e.g., a touchpad or physical click wheel). Contact/motion module 130 includes various software components for performing various operations related to detection of contact, determining if there is movement of the contact and tracking the movement across the touch-sensitive surface, and determining if the contact has ceased. Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multi-touch”/multiple finger contacts). In some embodiments, contact/motion module 130 and display controller 156 detect contact on a touchpad. Contact/motion module 130 may detect a gesture input by a user.

Graphics module 132 includes various known software components for rendering and displaying graphics on touch screen 112 or other display, including components for changing the intensity of graphics that are displayed. As used herein, the term “graphics” includes any object other than raw text that can be displayed to a user, including without limitation stylized text, web pages, icons (such as user-interface objects including soft keys), digital images, videos, animations and the like.

In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Text input module 134, which may be a component of graphics module 132, provides soft keyboards for entering text in various applications (e.g., contacts 139, e-mail 142, IM 143, browser 148, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Speech-to-Text (STT) module 136 converts (or employs a remote service to convert) speech signals captured by the microphone 113 into text. In some embodiments, the speech-to-text module 136 processes the speech signal in light of acoustic and/or language models build on a limited corpus of text, such as text within a textbook or storybook stored on the device 100. With a limited corpus of text, the speech-to-text conversion or recognition can be performed with less processing power, and memory requirement at the device 100, and without employing a remote service. The speech-to-text (STT) module 136 is optionally used by any of the applications 138 supporting speech-based inputs. In particular, the group reading applications 149 and various components thereof uses the STT module to process the user's speech signals, and trigger various functions and outputs based on the result of the STT processing.

Text-to-Speech module 137 converts (or employs a remote service to convert) text (e.g., text of an electronic story book, text extracted from a webpage, text of a textural document, text associated with a user interface element, text associated with a system notification event, etc.) into speech signals. In some embodiments, the text-to-speech module 137 provides the speech signal to the audio circuitry 110, and the speech signal is output through the speaker 111 to the user. In some embodiments, the text-to-speech module 137 is used to generate a sample reading, or support a virtual reader that participate in the group reading along with other human participants.

Applications 138 may include the following modules (or sets of instructions), or a subset or superset thereof: contacts module 139; telephone module 140; video conferencing module 141; e-mail client module 142; instant messaging (IM) module 143; camera module 144 for still and/or video images; image management module 145; video and music player module 146; notes module 147; and browser module 148.

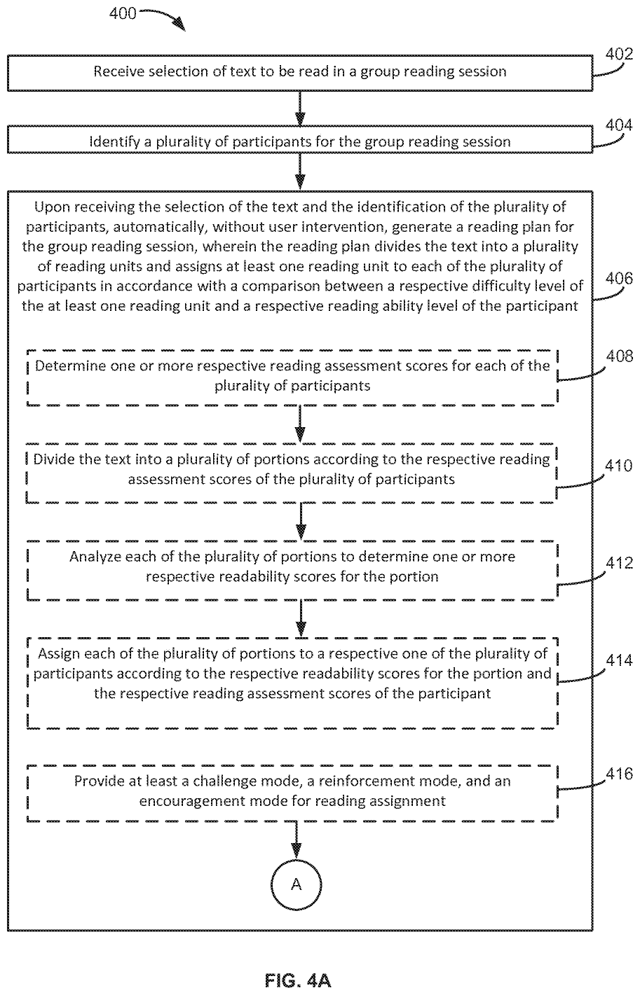

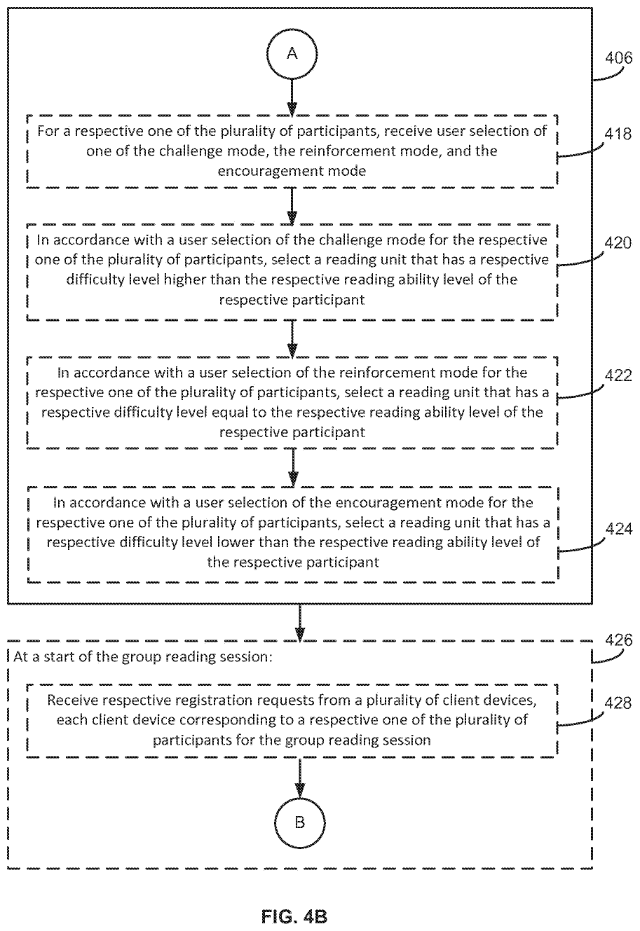

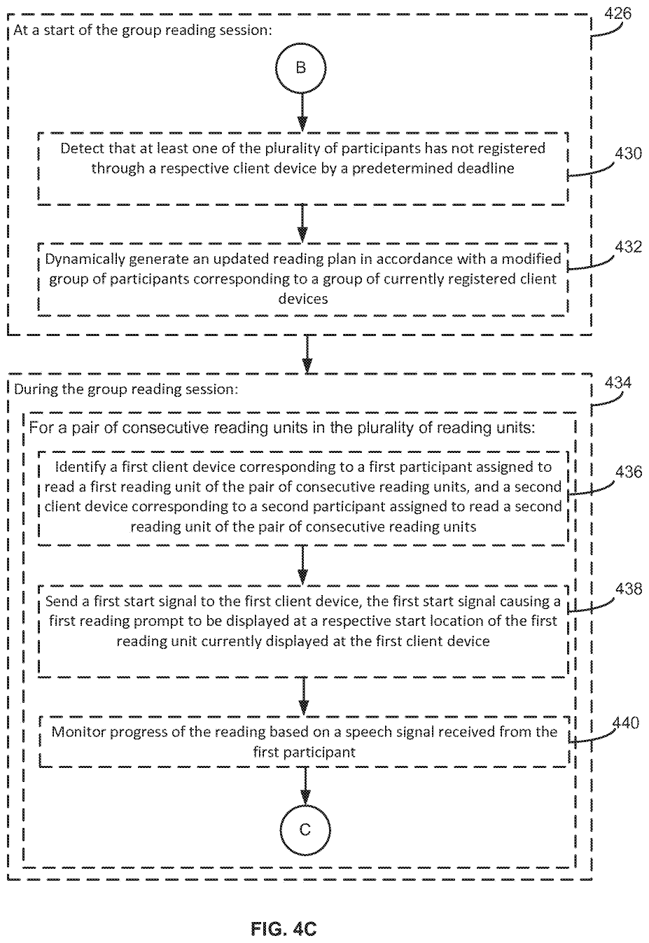

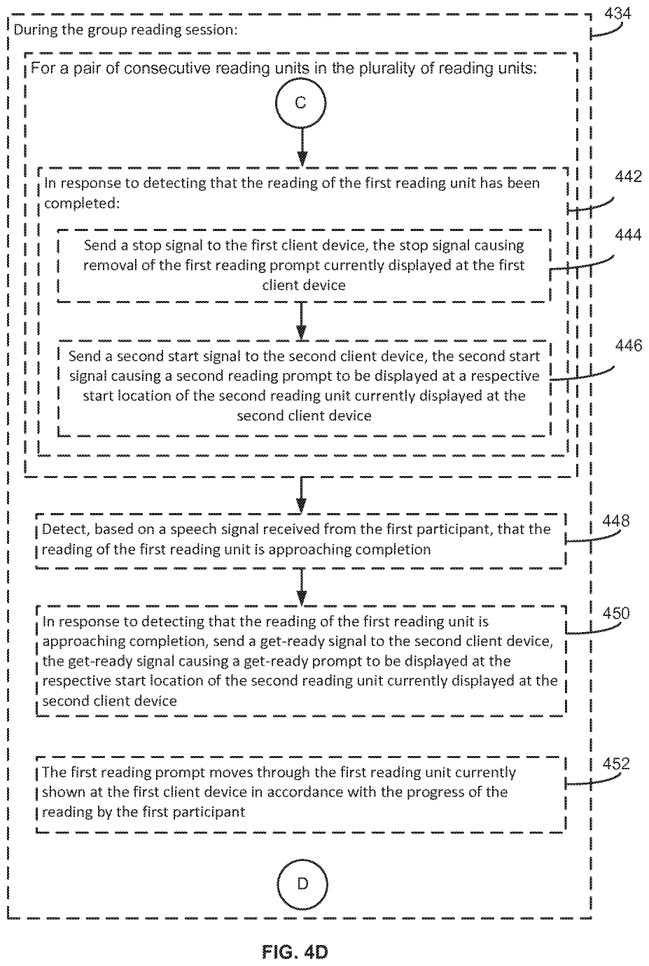

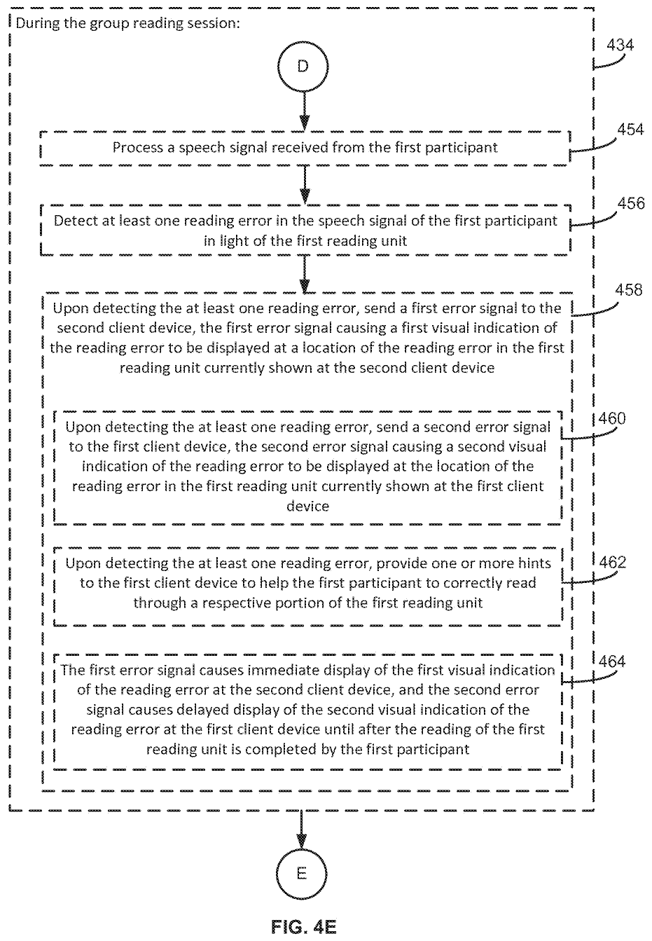

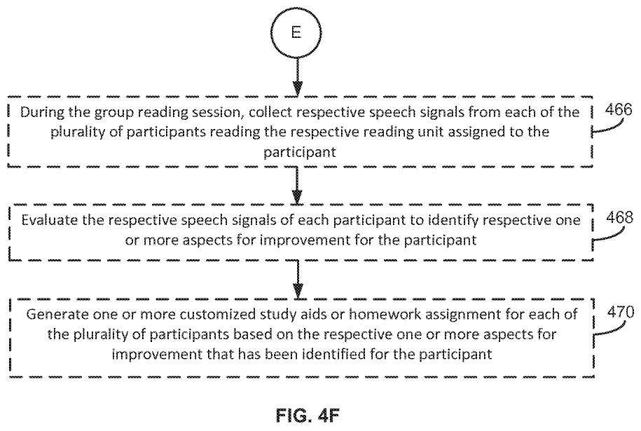

In some embodiments, applications 138 stored in memory 102 also include one or more group reading applications 149. The group reading applications 149 include various modules to facilitate various functions useful in a group reading session. In some embodiments, the group reading applications 149 include one or more of: a group reading organizer module 150, a group reading participant module 151, a reading plan generator module 152, an assignment receiver module 153, an assignment checker module 154, a text displayer module 155, a illustration displayer module 156, a reader switching module 157, a reading material selection module 158, and a reading material storing module 159. Not all of the modules 150-159 need to be included in a particular embodiment. Some functions of one or more modules 150-159 may be combined into the same module or divided among several modules. More details of the various group reading applications 148 are described with respect to FIGS. 4A-4F, 5A-5B, 6A-6B, 7A-7D, 8A-8B, 9A-9B, and 10A-10H. In some embodiments, the memory 102 also stores electronic reading materials (e.g., books, documents, articles, stories, etc.) in a local e-book storage 160. Modules providing other functions described later in the specification are also optionally implemented in accordance with some embodiments.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

FIG. 2 illustrates a portable multifunction device 100 having a touch screen 112 in accordance with some embodiments. The touch screen may display one or more graphics and text within user interface (UI) 200. In this embodiment, as well as others described below, a user may select one or more of the graphics by making a gesture on the graphics, for example, with one or more fingers 202 (not drawn to scale in the FIG.) or one or more styluses 203 (not drawn to scale in the FIG.). In some embodiments, selection of one or more graphics occurs when the user breaks contact with the one or more graphics. In some embodiments, the gesture may include one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 204. As described previously, menu button 204 may be used to navigate to any application 138 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

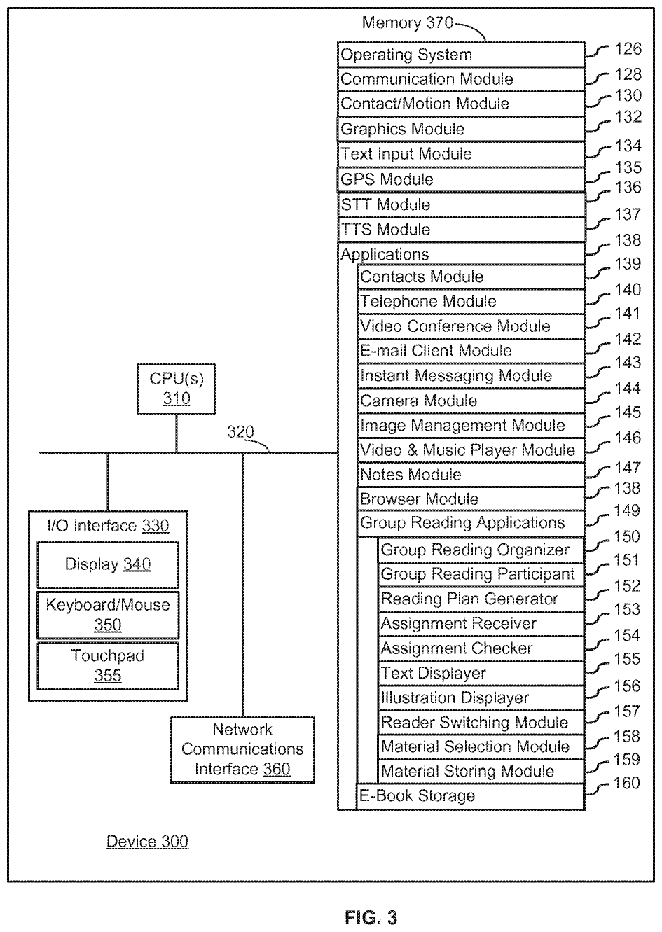

FIG. 3 is a block diagram of an exemplary multifunction device with a non-touch-sensitive display. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 may include circuitry (sometimes called a chipset) that interconnects and controls communications between system components. Device 300 includes input/output (I/O) interface 330 comprising display 340, which is typically a touch screen display. I/O interface 330 also may include a keyboard and/or mouse (or other pointing device) 350 and touchpad 355. Memory 370 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 370 may optionally include one or more storage devices remotely located from CPU(s) 310. In some embodiments, memory 370 stores programs, modules, and data structures analogous to the programs, modules, and data structures stored in memory 102 of portable multifunction device 100 (FIG. 1), or a subset thereof. Furthermore, memory 370 may store additional programs, modules, and data structures not present in memory 102 of portable multifunction device 100.

Each of the above identified elements in FIG. 3 may be stored in one or more of the previously mentioned memory devices. Each of the above identified modules corresponds to a set of instructions for performing a function described above with respect to FIG. 1. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

### User Interfaces and Associated Processes

Attention is now directed towards embodiments of user interfaces (“UI”) and associated processes that may be implemented on an electronic device, such as device 300 or portable multifunction device 100.

FIGS. 4A-4F is a flow chart of an exemplary process 400 for generating a reading plan for a group reading session and facilitating the reading by multiple participants during the group reading session. In some embodiments, the exemplary process 400 is performed by a primary user device (e.g., a device 100 or a device 300) operated by an instructor, a reading group leader, or a reading group organizer. The primary user device generates a group reading plan for a group of participants. The group of participants each operates a secondary user device (e.g., another device 300 or another device 100) that communicates with the primary user device before, during, and/or after the group reading session to accomplish various functions needed during the group reading session. In some embodiments, the primary user device is elected from among a group of user devices operated by the participants of the group reading session, and performs both operations of a primary user device and the operations of a secondary user device during the group reading session.

In the process 400, a group reading plan is generated for a group reading session before the start of the group reading session. For example, an instructor optionally invokes the process 400 before a class, and generates a text reading plan for use during the class. In another example, a parent optionally invokes the process 400 before a story session with his/her children, and generates a story reading plan for the story session with his/her children. In another example, a director of a school play optionally generates a script reading plan for later use during a rehearsal. In another example, a book club organizer optionally invokes the process 400 before a book club meeting to generate a book reading plan for use during the club meeting. The process 400 may also be used for other group reading settings, such as bible studies, study groups, and foreign language training, etc.

Referring to FIG. 4A, a primary user device having one or more processors and memory receives (402) selection of text to be read in a group reading session. In some embodiments, the text to be read in the group reading session is a story, an article, an email, a book, a chapter from a book, a manually selected portion of text in a textual document, a news article, or any other textual passages suitable to be read aloud by a user.

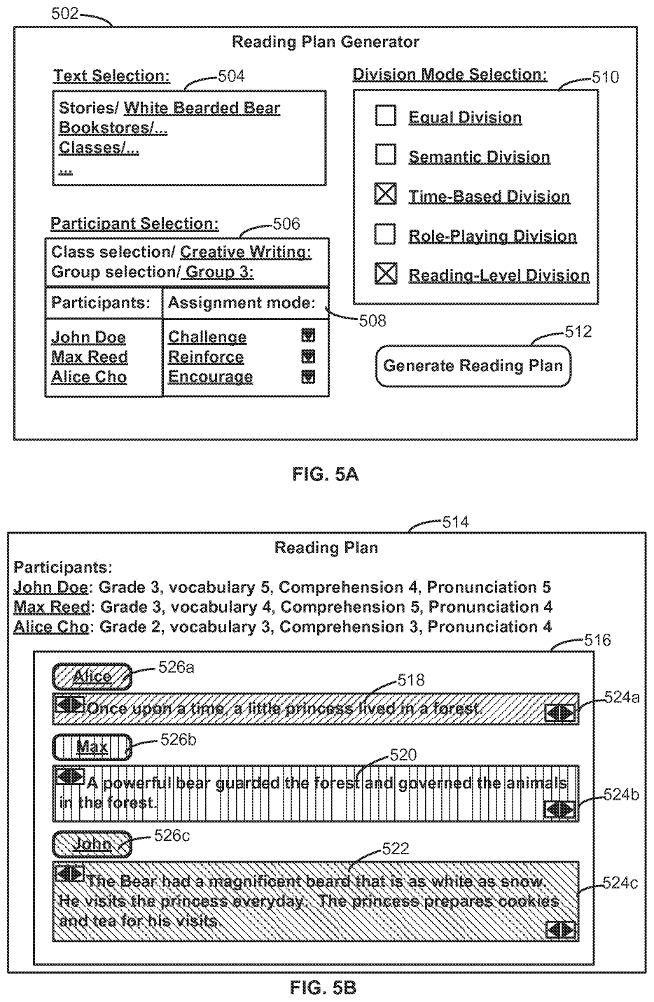

In some embodiments, the primary user device provides a reading plan generator interface (e.g., UI 502 shown in FIG. 5A), and allows a user of the primary user device to select the text to be read in the group reading session. As shown in FIG. 5A, a text selection UI element 504 allows the user to select available text for reading during the group reading session. In some embodiments, the available text is selectable from a drop down menu. In some embodiments, the text selection UI element 504 also allows the user to browse a file system folder to select the text to be read in the group reading session. In some embodiments, the text selection UI element 504 allows the user to paste or type the text to be read into a textual input field. In some embodiments, the text selection UI element 504 allows the user to drag and drop a document (e.g., an email, a webpage, a text document, etc.) that contains the text to be read during the group reading session into the text input field. In some embodiments, the text selection UI element 504 provides links to a network portal (online bookstores, or online education portals) that distributes electronic reading materials to the user. As shown in FIG. 5A, the user has selected a story “White-Bearded Bear” to be read in the group reading session.

In some embodiments, the reading plan generator interface 502 is provided over a network, and through a web interface. In some embodiments, the web interface provides a log-in process, and the text selection input is automatically populated for the user based on the login information entered by the user. For example, if a reading material has been assigned to a particular reading group associated with the user, the text selection input area provided by the UI element 504 is automatically populated for the user, when the user provides the proper login information to access the reading plan generator interface 504.

In some embodiments, the text to be read during a particular reading session is predetermined based on the current date. For example, in some embodiments, a front page news article of the current day is automatically selected as the text for reading in a group reading session that is to occur on the current day or the next day.

Referring back to FIG. 4A, the primary user device identifies (404) a plurality of participants for the group reading session. For example, in some embodiments, as shown in FIG. 5A, the primary user device provides a participant selection UI element 506. In some embodiments, the participant selection UI element 506 allows the user to individually select participants for the group reading session one by one, or select a preset group of participants (e.g., students belonging to a particular class or a particular study group, etc.) for the group reading session. In some embodiments, the available participants are optionally provided to the primary user device using a file, such as a spreadsheet or text document. In some embodiments, the participants of the group reading session are automatically identified and populated for the user based on the user's login information.

In this particular example, as shown in FIG. 5A, the user has selected three participants (e.g., John, Max, and Alice) for the group reading session. More or fewer participants can be selected for each particular reading session. In some embodiments, the user of the primary user device optionally includes him/herself as a participant of the group reading session. For example, if an older brother is using the primary user device to generate a group reading plan for his little sister, the older brother optionally specifies himself and his little sister as the participants of the group reading session.

Referring back to FIG. 4A, upon receiving the selection of the text and the identification of the plurality of participants, the primary user device automatically, without user intervention, generates (406) a reading plan for the group reading session. In some embodiments, the reading plan divides the text into a plurality of reading units and assigns at least one reading unit to each of the plurality of participants. In some embodiments, a reading unit represents a continuous segment of text within the text to be read during the group reading session. In general, a reading unit includes at least one sentence. In some embodiments, a reading unit includes one or more passages of text. In some embodiments, a reading unit includes one or more sub-sections or sections (e.g., text under section or sub-section headings) within the text. In some embodiments, for reading sessions involving young children, a reading unit may also include one or more words, or one or more phrases.

In some embodiments, the reading plan divides the selected text and assigns the resulting reading units in accordance with a comparison between a respective difficulty level of the reading unit(s) and a respective reading ability level(s) of the participant(s). For example, for a group of children with lower reading ability levels, the reading plan optionally divides the text into a number of reading units such that each child gets assigned several shorter and easier segments of text to read during the group reading session. In contrast, for a group of older students, the lesson plan divides the text into a different number of reading units such that each student receives one or two long passages of text to read during the group reading session. In some embodiments, the number of reading units generated by the device depends on the number of participants identified for the group reading session. For example, the number of reading units is optionally multiples of the number of participants.

In some embodiments, the reading ability level is measured by a combination of several different scores each measuring a respective aspect of a user's reading ability, such as vocabulary, pronunciation, comprehension, emotion, speed, fluency, prosody, etc. In some embodiments, the difficulty level of the text and/or the difficulty of the reading units are also measured by a combination of several different scores each measuring a respective aspect of the reading unit's reading accessibility, such as length, vocabulary, structural complexity, grammar complexity, emotion, pronunciation, etc. In some embodiments, the reading ability level of the user and the reading difficult level of the reading unit are measured by a matching set of measures (e.g., vocabulary, grammar, and complexity).

In some embodiments, automatically generating the reading plan further includes the following operations (408-414, and 416-424).

In some embodiments, the primary user device determines (408) one or more respective reading assessment scores for each of the plurality of participants. For example, the reading assessment scores are optionally the grades for each participant for a class. In another example, the reading assessment scores are optionally generated based on an age, class year, or education level of each participant. In another example, the reading assessment scores are optionally generated based on evaluation of past performances in prior group reading sessions. In some embodiments, the reading assessment scores for each participant are provided to the user device in the form of a file.

In some embodiments, the primary user device divides (410) the text into a plurality of contiguous portions according to the respective reading assessment scores of the plurality of participants. For example, if a majority of participants have low reading assessment scores, the primary user device optionally divides the text into portions that are relatively easy for the majority of participants, and leaves only one or more difficult portions for the few participants that have relatively high reading assessment scores.

In some embodiments, the primary user device analyzes (412) each of the plurality of portions to determine one or more respective readability scores for the portion. In some embodiments, the primary user device assigns (414) each of the plurality of portions to a respective one of the plurality of participants according to the respective readability scores for the portion and the respective reading assessment scores of the participant.

In some embodiments, the primary user device provides several reading assignment modes for selection by the user for each participant. In some embodiments, the primary user device provides (416) at least two of a challenge mode, a reinforcement mode, and an encouragement mode for selection by the user for each participant. For example, as shown in FIG. 5A, the reading plan generator interface 502 provides an assignment mode selection element 508 for choosing the assignment mode for each participant. In some embodiments, the assignment mode selection element 508 is a drop down menu showing the different available assignment modes.

Referring now to FIG. 4B, in some embodiments, the primary user device receives (418), for a respective one of the plurality of participants, user selection of one of the challenge mode, the reinforcement mode, and the encouragement mode. For example, as shown in FIG. 5A, the user has selected the challenge mode for the first participant John, the reinforcement mode for the second participant Max, and the encouragement mode for the third participant Alice.

In some embodiments, a single mode selection is optionally applied to all or multiple participants in the group reading session. In some embodiments, the assignment of reading units in the challenge mode aims to be somewhat challenging to a participant in at least one aspect measured by the primary user device, while the assignment of reading units in the encouragement mode aims to be somewhat easy or accessible to a participant in all aspects measured by the primary user device. In some embodiments, the assignment of reading units in the reinforcement mode aims to provide reinforcement in at least one aspect measured by the primary user device which the participant has shown recent improvement. In some embodiments, more or fewer assignment modes are provided by the primary user device. In some embodiments, a respective assignment mode needs not be specified for all participants of the group reading session.

In some embodiments, in accordance with a user selection of the challenge mode for the respective one of the plurality of participants, the primary user device selects (420) a reading unit that has a respective difficulty level higher than the respective reading ability level of the respective participant. In some embodiments, in accordance with a user selection of the reinforcement mode for the respective one of the plurality of participants, the primary user device selects (422) a reading unit that has a respective difficulty level comparable or equal to the respective reading ability level of the respective participant. In some embodiments, in accordance with a user selection of the encouragement mode for the respective one of the plurality of participants, the primary user device selects a reading unit that has a respective difficulty level lower than the respective reading ability level of the respective participant.

In some embodiments, additional modes are provided for selection by the user to influence the division of the selected text into appropriate reading units, and the assignments of the reading units to the plurality of participants. For example, as shown in FIG. 5A, a divisional mode selection UI element 510 is provided for the user to select one or more of several text division modes. Example text division modes include an equal division mode, a semantic division mode, a time-based division mode, a role-playing division mode, a reading-level division mode, and/or the like. In some embodiments, in the equal division mode, each participant receives reading units of substantially equal length and/or difficulty. In some embodiments, in the semantic division mode, the primary user device divides the text into reading units based on the semantic meaning of the text, and the natural semantic transition points in the text. In some embodiments, in the time-base division mode, the primary user device divides the text into reading units that would take a certain predetermined amount of time to read (e.g., 2-minute segments). In some embodiments, in the role-playing division mode, the primary user device automatically recognizes the different roles (e.g., narrator, character A, character B, character C, etc.) present in the selected text, and divides the text into reading units that are each associated with a respective role. In some embodiments, in the reading-level division mode, the text is divided into reading units at different reading difficulty levels that match the reading ability levels of the participants.

In some embodiments, the user is allowed to select more than one division mode for a particular group reading session, and the primary user device divides the text in accordance with all of the selected division modes. In some embodiments, a priority order is used to break the tie if a conflict arises due to the concurrent selection of multiple division modes.

As shown in FIG. 5A, after the inputs required for the reading plan has been provided, the user can select the “generate reading plan” button 512 in the reading plan generator interface 502. In response, the primary user device generates the reading plan and provides the reading plan to the user for review and editing. FIG. 5B is an example reading plan review interface 514 showing the group reading plan 516 that has been automatically generated by the primary user device.

In some embodiments, the reading plan review interface 514 includes the participant information of the group reading session. In some embodiments, the reading plan review interface 514 optionally presents the reading assessment scores for each participant. In some embodiments, the reading plan review interface 514 optionally includes the division and/or assignment modes used to divide and assign the reading units for the group reading session (not shown).

As shown in FIG. 5B, in some embodiments, the group reading plan review interface 514 presents the text to be read in the group reading session in its entirety, and visually distinguish the different reading units assigned to the different participants. For example, the reading units assigned to each participant are optionally highlighted with a different color, enclosed in a respective frame or bracket labeled by an identifier of the participant.

In some embodiments, the user is optionally allowed to move the beginning and/or end points of each reading unit, and/or to change the assignment of the reading unit manually. As shown in FIG. 5B, the first reading unit 518 of the selected text has been assigned to Alice, the second reading unit 520 of the selected text has been assigned to Max, the third reading unit 522 of the selected text has been assigned to John. Each of the reading units 518, 520, and 522 are shown in a respective frame 524a-524c. In some embodiments, the user can drag the two ends of each frame 524 to adjust the boundary location of the corresponding reading unit. In some embodiments, respective user interface elements (e.g., a pair of scrolling arrows) are provided to adjust the boundary locations of each reading unit. In some embodiments, as the user adjusts one end point of a particular reading unit, the adjoining end point of its adjacent reading unit is automatically adjusted accordingly. In some embodiments, the user is allowed to change the assignment of a particular frame to a different participant, e.g., by clicking on the participant label 526 of the frame 524.

In some embodiments, the group reading plan is stored as an index file specifying the respective beginning and end points of the reading units, and the assigned participant for each reading unit. In some embodiments, the primary user device generates the reading plan review interface 514 based on the index file, and revises the index file based on input received in the reading plan review interface 514. In some embodiments, the reading plan review interface 514 optionally includes a user interface element for sending the reading assignments to the participants before the group reading session. In some embodiments, to ensure that each participant prepares for reading the entire text, the assignment is not made known to the participant until the beginning of the group reading session.

Referring back to FIG. 4B, in some embodiments, at the start of the group reading session, the primary user device receives (426) respective registration requests from a plurality of client devices (or secondary user devices), each client device corresponding to a respective one of the plurality of participants for the group reading session. For example, in some embodiments, the primary user device is an instructor's device, and the client devices are students' devices. When the students arrive in a classroom, the students' individual devices communicate with the instructor's device to register with the instructor's device. In some embodiments, at least some of the client devices register with the instructor's device remotely through one or more networks. In some embodiments, if the user of the primary user device is to participant in the group reading as well, the primary user device need not register with itself. Instead, the user of the primary user device merely needs to select an option provided by the reading plan generator to participate in the group reading session as a participant. In some embodiments, each client device is required to pass an authentication process to send the registration request.

Referring to FIG. 4C, in some embodiments, the primary user device detects (428) that at least one of the plurality of participants has not registered through a respective client device by a predetermined deadline. For example, if a participant is absent from the group reading session, and the primary user device does not receive registration request by the scheduled start time of the group reading session, the primary user device determines that the participant is no longer available for reading in the group reading session. In some embodiments, the primary user device dynamically generates (530) an updated reading plan in accordance with a modified group of participants corresponding to a group of currently registered client devices. For example, in some embodiments, each client device identifies a respective participant in its registration request, and the primary user device is thus able to determine which participants are actually present to participant in the group reading session, and regenerates the reading plan based on these participants. In some embodiments, the primary user device optionally presents the modified reading plan to the user of the primary user device for review and revisions.

In some embodiments, during the group reading session, the primary user device performs (434) the following operations to facilitate the reading transition from participant to participant during the reading.

In some embodiments, for a pair of consecutive reading units (e.g., for each pair of consecutive reading units) in the plurality of reading units, the primary user device identifies (436) a first client device corresponding to a first participant assigned to read the first reading unit of the pair of consecutive reading units, and a second client device corresponding to a second participant assigned to read a second reading unit of the pair of consecutive reading units. For example, according to the reading plan shown in FIG. 5B, a pair of consecutive reading units 518a and 520 are assigned to two participants Alice and Max, respectively. Another pair of consecutive reading units 520 and 522 are assigned to two participants Max and John. The primary user device identifies the respective user devices of Alice, Max, and John, e.g., through their respective registration requests.

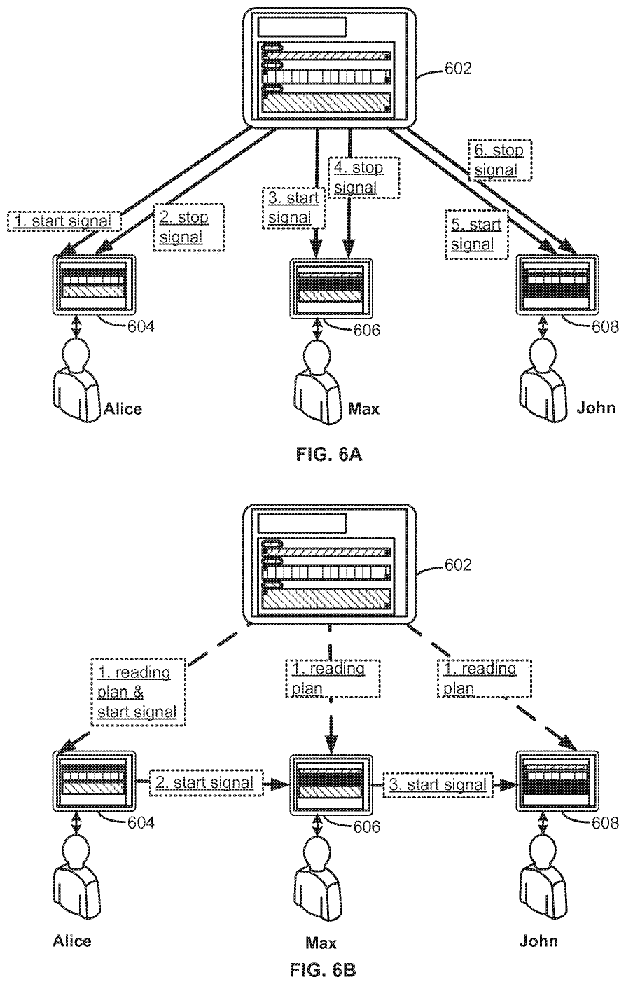

In some embodiments, the primary user device sends (438) a first start signal to the first client device, the first start signal causing a first reading prompt to be displayed at a respective start location of the first reading unit currently displayed at the first client device. As shown in FIG. 6A, after the group reading session has started, the primary user device 602 (e.g., served by a first user device 300 or 100) identifies that the first reading unit (e.g., reading unit 518) is assigned to Alice, and sends a first start signal to the first client device 604 (e.g., served by another user device 300 or 100) operated by Alice. In response to receiving the first start signal from the primary user device 602, the first client device 604 displays a first reading prompt at the start location of the first reading unit (e.g., reading unit 518) that has been assigned to Alice. In some embodiments, the entirety of the first reading unit is highlighted on the first client device 604 in response to the receipt of the first start signal. Since the same first start signal is not sent to the other client devices 606 and 608 operated by the other participants (e.g., Max and John), no reading prompt is displayed on the client devices 606 and 608 when the first reading prompt is displayed on the first client device 604.

In some embodiments, at the start of the group reading session, the entirety of the text to be read in the group reading session has been displayed on each participant's respective device, so that all participants can see the text on their respective devices. When the first reading prompt is displayed on the first client device 604 and not on the client devices 606 and 608 operated by the other participants (e.g., Max and John), Alice knows that it is her turn to read the highlighted reading unit aloud, while the other participants listens to her reading.

In some embodiments, the primary user device 602 monitors (440) progress of the reading based on a speech signal received from the first participant. For example, in some embodiments, the speech signal from the first participant (e.g., Alice) can be captured by a microphone of the first client device 604, and forwarded to the primary user device 602, where the primary user device 602 processes the speech signal (e.g., using speech-to-text) to determine the progress of the reading through the first reading unit. In such embodiments, the client devices (e.g., client device 604) are not required to perform the speech-to-text processing onboard, which can require a substantial amount of memory and processing resources. In some embodiments, the primary client device 602 captures the speech signal directly from the first participant (e.g., Alice) when the participant is located sufficiently close to the primary user device 602 (e.g., in the same room).

In some embodiments, the first client device 604 captures the speech signal from the first participant, processes the speech signal against the first reading unit to determine the progress of the reading, and sends the result of the monitoring to the primary user device 602. In such embodiments, the individual client device only needs to consider the text within the reading unit when processing the speech signal. Therefore, the processing and resource requirement on the individual client device is relatively small.

In some embodiments, as the primary user device monitors the progress of the reading by the first participant, the primary user device optionally sends signals to the other client devices regarding the reading by the first participant. For example, the primary reading device 602 optionally sends additional signals regarding the pronunciation, speed, emotion detected in the speech signal reading the first reading unit to the first client device 604, and/or other client devices (e.g., devices 606 and 608) in the group reading session. In response to these additional signals, the receiving client devices optionally display pop-up notes, highlighting, hints, dictionary definitions, and other visual information (e.g., a bouncing ball) related to the text and the first participant's reading of the first reading unit.

Referring back to FIG. 4D, in some embodiments, in response to detecting that the reading of the first reading unit has been completed, the primary user device performs (442) the following operations. In some embodiments, the primary user device sends (444) a stop signal to the first client device, the stop signal causing the removal of the first reading prompt shown at the first client device. In some embodiments, the primary user device sends (446) a second start signal to the second client device, the second start signal causing a second reading prompt to be displayed at a respective start location of the second reading unit currently displayed at the second client device.

For example, as shown in FIG. 6A, when the primary user device 602 determines that the text in the first reading unit has been completely detected in the speech signal captured from the first participant (e.g., Alice), the primary user device 602 determines that the reading of the first reading unit has been completed (e.g., by Alice). The primary user device 602 then sends a stop signal to the first client device 604. In response to the stop signal, the first client device 604 ceases to display the first reading prompt, such that Alice knows that she can now stop reading the remaining portions of the text. In some embodiments, if the first reading unit has been highlighted previously, the highlighting is removed from the text of the first reading unit. In some embodiments, if a reading prompt (e.g., a bouncing ball or underline) has been moving through the text of the first reading unit synchronously with the progress of the reading by Alice, the reading prompt is removed from the text displayed on the first client device. In some embodiments, if some comments or information on Alice's reading had been sent to the other client devices while Alice is reading the first reading unit, these comments are optionally sent to the first client device 604 with the stop signal, so that the comments and information can be shown to Alice as well after her reading is completed. In some embodiments, notes and comments by other participants collected by the primary user device 602 during Alice's reading are optionally sent to the first client device 604 and displayed to Alice as well.

As shown in FIG. 6A, in some embodiments, the primary user device 602 also determines that the next reading unit immediately following the first reading unit has been assigned to the participant Max, and that the second client device 606 is operated by Max. When the reading of the first reading unit by Alice has been completed, the primary user device 602 sends a second start signal to the second client device 606 operated by Max. In response to receiving the second start signal, the second client device 606 displays a second reading prompt to the Max indicating the start of the second reading unit assigned to Max. Since the second start signal is not sent to the other client devices 604 and 608 operated by the other participants (e.g., Alice and John), no reading prompt is displayed on the client devices 604 and 608 when the second reading prompt is displayed at the client devices 606. When Max sees the second reading prompt displayed on his device 606, Max can start reading the second reading unit aloud, while the other participants (e.g., Alice and John) listen to the reading of the second reading unit by Max.

In some embodiments, the primary user device 602 treats the second client device 606 (e.g., Max's device) as the first reading unit of the next pair of consecutive reading units 520 and 522 in the selected text, and monitors the progress of the reading by Max. When Max has completed the reading of the second reading unit 520 (i.e., the earlier one of the pair of reading units 520 and 522), the primary user device 602 sends a second stop signal to Max's device to cause the removal of the second reading prompt from Max's device 606. The primary user device 602 further sends a third start signal to the third client device 608 operated by the next participant John who has been assigned the latter reading unit 522 of the next pair of consecutive reading units 620 and 522. In response to receiving the third start signal, the third client device 608 displays the reading prompt at the start of the reading unit 522 current displayed at client device 608. This process can continue as the participants read through the reading units in the text one by one, and the reading prompt hops from one client device to the next according to the assignment specified in the group reading plan (e.g., reading plan 516). In some embodiments, one participant may be assigned multiple non-consecutive reading units, and the reading prompt will return to the device of the participant when it is that participant's turn to read one of his/her assigned reading units.

Referring back to FIG. 4D, in some embodiments, in addition to the stop signals and start signals, the primary user device optionally sends a get-ready signal to a client device before sending the start signal to the client device. In some embodiments, the primary user device detects (448), based on a speech signal received from the first participant, that the reading of the first reading unit is approaching completion. In response to detecting that the reading of the first reading unit is approaching completion, the primary user device optionally sends (450) a get-ready signal to the second client device, where the get-ready signal causes a get-ready prompt to be displayed at the respective start location of the second reading unit currently displayed at the second client device.

For example, in FIG. 6A, when the primary user device 606 detects that Alice has finished reading ninety percent of the text in the first reading unit 518, the primary user device 602 sends a get-ready signal to the second client device 606. The second client device 606, upon receiving the get-ready signal from the primary user device 602, displays a get-ready prompt at the start location of the second reading unit 520 to prompt Max to get ready to read. In addition, after the primary user device 602 detects that Max has finished reading ninety percent of the text in the second reading unit 520, the primary user device 602 sends a get-ready signal to the third client device 608. The third client device 608, upon receiving the get-ready signal, displays a get-ready prompt to prompt John to get ready to read. In some embodiments, the get-ready prompt is not necessarily displayed at the start of the reading unit to be ready next. For example, in some embodiments, the get-ready prompt is merely a visual indicator (e.g., a blinking icon) to alert the next participant to get ready to start reading soon.

Referring back to FIG. 4D, in some embodiments, each reading prompt (e.g., the first reading prompt) moves (452) through the respective reading unit for which the prompt is displayed (e.g., the first reading unit currently displayed on the first client device) in accordance with the progress of the reading by the respective participant (e.g., the first participant to whom the first reading unit has been assigned).

Referring to FIG. 4E, in some embodiments, during the group reading session, the primary user device processes (454) a speech signal received from the first participant. The primary user device determines whether at least one reading error is present in the speech signal of the first participant in light of the first reading unit. In some embodiments, the primary user device detects (456) at least one reading error in the speech signal of the first participant in light of the first reading unit. In some embodiments, upon detecting the at least one reading error, the primary user device sends (458) a first error signal to the second client device (rather than the first client device), where the first error signal causes a first visual indication of the reading error to be displayed at a location of the reading error in the first reading unit currently displayed at the second client device.

In some embodiments, the primary user device sends the same first error signal to each of the client devices of the participants who are not currently reading, and causes the first visual indication of the reading error to be displayed on these client devices. For example, if the primary user device detects that the first participant (e.g., Alice) has mispronounced or misread a particular word in the first reading unit 518, the primary user device sends an error signal to the second user device (e.g., the device operated by Max) to alert the listening participant (e.g., Max) that the particular word has been mispronounced or misread. Optionally, the mispronounced/misread word is highlighted on the devices of the listening participants, and the correct pronunciation is visually indicated on those devices.

In some embodiments, during the group reading session, the primary user device, upon detecting the at least one reading error in the speech signal of the first participant (e.g., Alice), sends (460) a second error signal to the first client device (e.g., device operated by Alice), where the second error signal causes a second visual indication of the reading error to be displayed at the location of the reading error in the first reading unit (e.g., reading unit 518) currently shown at the first client device. For example, if the primary user device detects that the first participant (e.g., Alice) has mispronounced or misread a particular word in the first reading unit (e.g., reading unit 518), the primary user device sends an error signal to the first user device to alert the current reader (e.g., Alice) that the particular word has been mispronounced or misread. Optionally, the mispronounced/misread word is highlighted on the device of the current reader, and the correct pronunciation is visually indicated on the device, such that the reader is aware of the error, and may re-read the incorrect portion of the first reading unit.

In some embodiments, the primary user device provides (462) one or more hints to the first client device to help the first participant to correctly read through a respective portion of the first reading unit (e.g., a portion in which a reading error has been made and/or a portion for which reading speed has slowed down). In some embodiments, more or fewer hints are provided depending on whether the first participant is in the challenge mode, the reinforcement mode, or the encouragement mode. For example, fewer hints are provided to participants reading in the challenge mode, while more hints are provided to participants reading the encouragement mode. In some embodiments, the primary user device dynamically adjust the number and/or type of hints provided based on an evaluation of the reading by the current reader (e.g., Alice).

In some embodiments, the primary user device provides two different kinds of error signals (e.g., the first error signal and the second error signal) to the listening participant(s)' device(s) and the current reader's device, respectively. In some embodiments, the first error signal causes (464) immediate display of the first visual indication of the reading error at the second client device (i.e., the listening participant's device), while the second error signal causes delayed display of the second visual indication of the reading error at the first client device (i.e., the current reader's device) until after the reading of the first reading unit is completed by the first participant.

In some embodiments, in addition or in lieu of a group reading session in which the participants reading aloud the text units displayed in front them, the same process 400 or a similar process is optionally used to facilitate a group reading session in which the participants recite the text units assigned to them without seeing the text units displayed in front of them during their respective recitations. This is particularly useful for learning and reciting lines for a play or other theatrical performances. For example, in some embodiments, while text are displayed on devices of all participants at the beginning of the reading session, as soon as a first start signal is send to the first client device, text of the first reading unit is obfuscated (e.g., the first reading prompt optionally blocks the text of the first reading unit) on the first client device. While the first participant recites out loud from memory the text of the first reading unit, the text of the first reading unit continues to be displayed on the devices of the listening participants. When the recitation of the first reading unit is completed by the first participant, the primary user device sends a stop signal to the first client device, and the first client device removes the reading prompt from the first client device. Upon removal of the first reading prompt, the text of the first reading unit is revealed again on the first client device. At the same time, the primary user device sends a second start signal to the second client device, and the second start signal causes a second reading prompt to be displayed on the second client device and causes the text of the second reading unit to be obfuscated on the second client device. The second participant can start recite the second reading unit out loud, while the other participants listen with the text of the second reading unit displayed on their respective devices.

In some embodiments, recitation errors are detected by the primary user device, and error signals are send to the listening participants' devices and/or the device of the participant that is currently reciting his/her assigned reading unit. In some embodiments, primary user devices sends an error signal to the device of the participant that is currently performing the recitation, and the device, upon receiving the error signal, displays the recitation error to that participant. For example, in some embodiments, only the words that were recited incorrectly are shown on the device of that participant.

In some embodiments, the primary user device displays the reading plan review interface 514 shown in FIG. 5B during the group reading session, and the reading unit that is currently read or recited aloud by a respective participant is visually highlighted in the reading plan review interface 514. As the reading of the text progresses from one reading unit to the next reading unit (i.e., from one participant to the next participant), the visual highlighting moves from reading unit to reading unit accordingly. In some embodiments, the primary user device receives a user input (e.g., from the instructor or reading group leader) to pause the reading. In response to the user input to pause the reading, the primary user device sends a stop signal to the device of the current reading/reciting participant either immediately or upon completion of the current reading unit, and suspends the issuance of the next start signal to the device of the next reading/reciting participant. In some embodiments, the primary device receives another user input to resume the reading. In response to the user input to resume the reading, the primary user device sends the next start signal that has been previously withheld, and the reading session can proceeds as described above. The ability to pause and resume the continued transition of reading control from reading unit to reading unit allows the instructor to introduce time for live discussions, comments, and explanation of the text that has just been read.

Referring to FIG. 4F, in some embodiments, during the group reading session, the primary user device collects (466) respective speech signals from each of the plurality of participants reading/reciting the respective reading unit(s) assigned to the participant. In some embodiments, the primary user device evaluates (468) the respective speech signals of each participant to identify respective one or more aspects for improvement for the participant. In some embodiments, the primary user device generates (470) one or more customized study aids or homework assignments for each of the plurality of participants based on the respective one or more aspects for improvement that has been identified for the participant. For example, in some embodiments, the different aspects for improvement includes vocabulary, speed, reading comprehension, prosody, emotion, sentence segmentation, pronunciation, etc. In some embodiments, the study aids include flash cards showing words that the participant had difficulty recognizing or pronouncing, recordings of exemplary reading of the reading unit(s) assigned to the participant, comments from other participants on the reading/recitation by the participant, etc. In some embodiments, the assignment includes additional text and reading materials containing vocabulary, grammar, sentences structures, and/or content similar or related to the reading units that were assigned to the participant, and/or provide additional opportunities for the participant to practice on the weaker points discovered in his/her reading during the group reading session.

In some embodiments, e.g., as shown previously in FIG. 6A, the primary user device 602 is responsible for sending the start and/or stop signals to the respective client devices of the participants during the group reading session. In some embodiments, the responsibility of sending the start signal to the device of the next participant needs not rest on the primary user device 602 alone. For example, in some embodiments, the client device of the current reading participant optionally determines whether the current reading participant has completed his/her reading of the current reading unit, and if so, the client device (instead of the primary user device 602) sends the start signal to the client device operated by the next participant, e.g., as shown in FIG. 6B. In some embodiments, each client device receives at least part of the reading plan from the primary user device, and based on the received part of the reading plan and the current progress of the reading, determines when to present a reading prompt to its respective user.

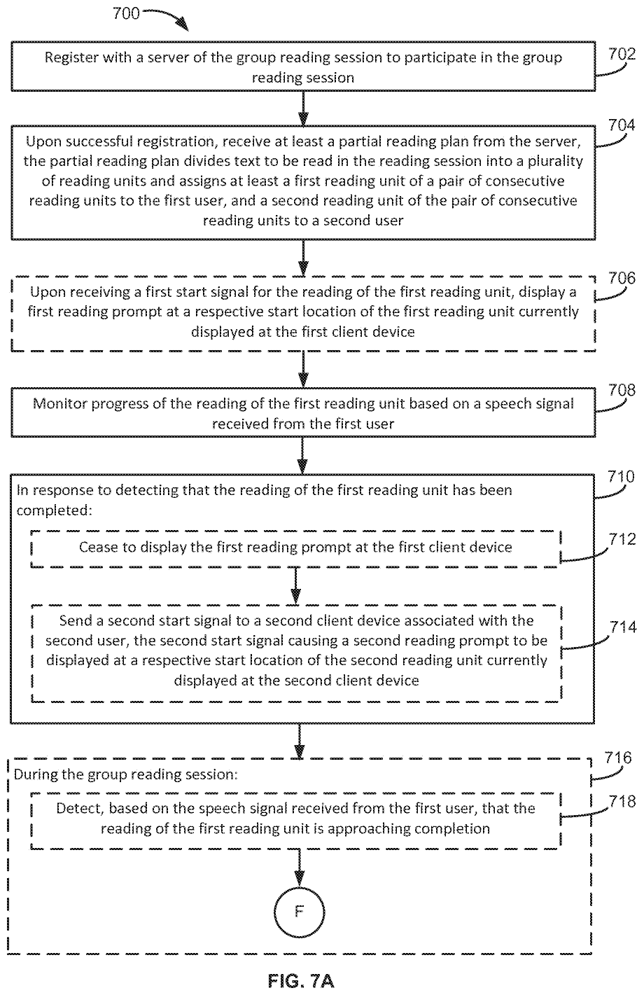

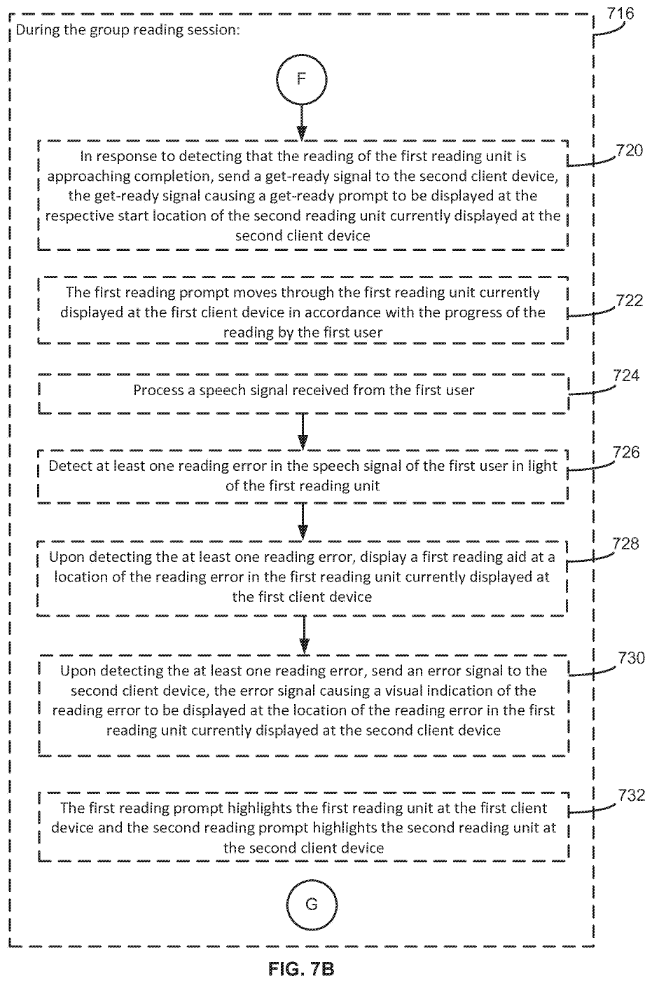

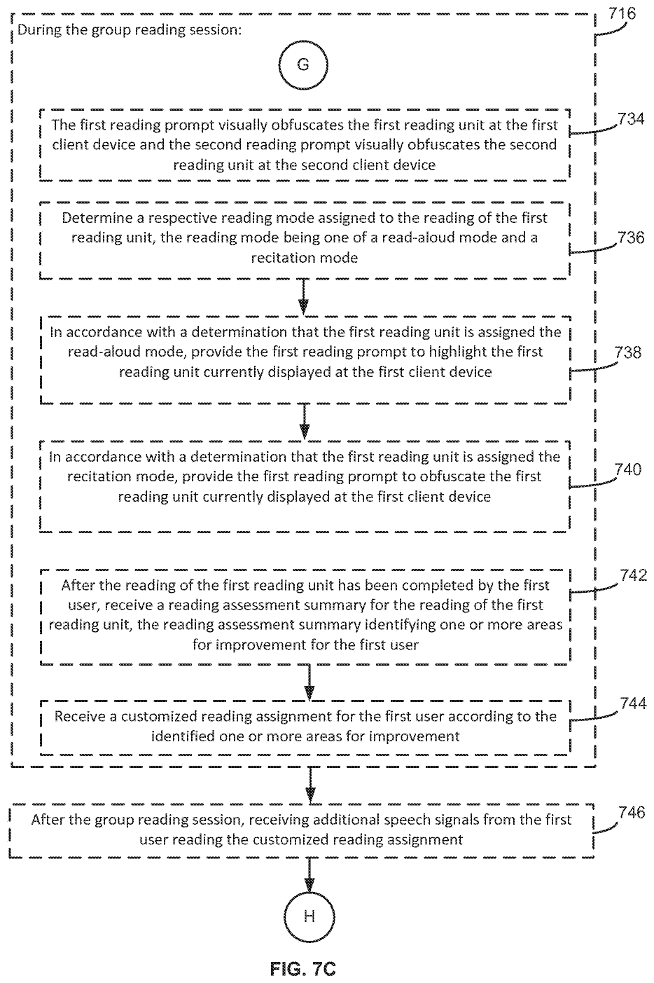

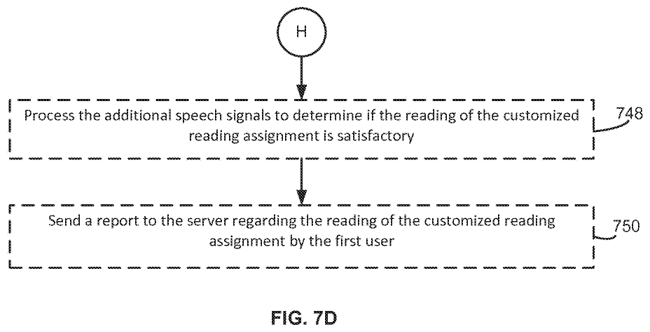

FIGS. 7A-7D is a flow chart of another exemplary process 700 for facilitating the reading of multiple participants during a group reading session. In some embodiments, the exemplary process 700 is performed by a primary user device operated by an instructor, a reading group leader, or a reading group organizer. In some embodiments, the exemplary process 700 is performed by a client device operated by one of the participants of the group reading. Some or all of the features described with respect to FIGS. 7A-7D may be combined with the features described with respect to FIGS. 4A-4F, 5A-5B, and 6A above, in accordance with various embodiments.

In the exemplary process 700, a first client device associated with a first user (e.g., the client device 604 associated with Alice shown in FIG. 6B) registers (702) with a server (e.g., the primary user device 602) of the group reading session to participate in the group reading session. In some embodiments, the server of the group reading session is the primary user device that has generated the reading plan. In some embodiments, the server of the group reading session is elected from the client devices operated by the plurality of participants.

In some embodiments, upon successful registration, the first client device receives (704) at least a partial reading plan from the server. In some embodiments, the reading plan divides the text to be read in the reading session into a plurality of reading units and assigns at least a first reading unit (e.g., reading unit 518 in FIG. 5B) of a pair of consecutive reading units (e.g., reading units 518 and 520) to the first user (e.g., Alice), and a second reading unit (e.g., reading unit 520 in FIG. 5B) of the pair of consecutive reading units to a second user (e.g., Max). In some embodiments, the server only sends, to each particular participant, portions of the reading plan that concern the particular participant and his/her succeeding participant in the reading plan. Based on the received portions of the reading plan, the first client device can determine which participant is to read after the first user has finished reading one of his/her assigned reading unit(s). In some embodiments, the server sends to each client device the network address or identifier of the other client devices participating in the group reading session. In some embodiments, the server sends the entire reading plan to the respective client devices of all of the participants.

In some embodiments, upon receiving a first start signal for the reading of the first reading unit, the first client device displays (706) a first reading prompt at a respective start location of the first reading unit currently displayed at the first client device. In some embodiments, if the first client device is operated by a participant who is assigned the very first reading unit of the text, the first client device optionally receives the start signal from the server (e.g., the primary user device). In some embodiments, if the first client device is operated by a participant who is assigned a reading unit after the very first reading unit of the text, the first client device optionally receives the start signal from the respective device of the participant who has been assigned the immediately preceding reading unit. For example, as shown in FIG. 6B, after the client devices 604, 606, and 608 have registered with the server (e.g., the primary user device 602) to join the group reading session, the server sends the reading plan to each of the client devices 604, 606, and 608. The client device 604 also optionally receives the start signal from the server 602, which causes the client device 604 to display a reading prompt on the first client device for the first participant (e.g., Alice) to start the reading/recitation of the first reading unit. In some embodiments, the first client device 604 optionally determines that it will have the first reading control based on the received reading plan, without requiring a start signal from the server.

In some embodiments, the first client device monitors (708) the progress of the reading of the first reading unit based on a speech signal received from the first user. In some embodiments, the first client device captures the speech signal directly from the first user, e.g., using a microphone coupled to the first client device. In some embodiments, the first client device converts the captured speech signal to text using an local STT function, and compares the converted text to the text of the first reading unit to determine the progress of the reading. In some embodiments, the first client device sends the speech signal to the server, and receives updates from the server regarding the progress of the reading. In some embodiments, other methods of monitoring the progress of the reading of the first reading unit are possible.

In some embodiments, in response to detecting that the reading of the first reading unit has been completed, the first client device performs (710) the following operations (712-714).

In some embodiments, in response to detecting that the reading of the first reading unit has been completed, the first client device ceases (712) to display the first reading prompt at the first client device. In some embodiments, in response to detecting that the reading of the first reading unit has been completed, the first client device further sends (714) a second start signal to a second client device associated with the second user (i.e., the user that is assigned to read the latter reading unit in the pair of consecutive reading units). The second start signal causes a second reading prompt to be displayed at a respective start location of the second reading unit currently displayed at the second client device. For example, as shown in FIG. 6B, after the first client device 604 detects that Alice has completed the reading of the first reading unit 518, the first client device 604 ceases to display the reading prompt at the first client device 604, and sends a second start signal to the second client device 606. The second client device 606, upon receiving the second start signal from the first client device 604, displays a reading prompt on the second client device to prompt Max to start reading the second reading unit 520. Then, the second client device 606 monitors the reading of the second reading unit 520 by Max. Upon detecting that Max has completed the reading of the second reading unit 520, the second client device 606 ceases to display the second reading prompt on the second client device 606, and sends a third start signal to the third client device 608. The third device 608, upon receiving the third reading prompt from the second client device 606, displays a third reading prompt on the third client device 608 for John to start the reading of the third reading unit 522. This process continues until all the reading units have been read, or when a pause signal is received from the server (e.g., the primary user device 602) by one of the client devices (e.g., the client device that has the current reading control) participating in the group reading session.

Referring back to FIG. 7A, in some embodiments, during the group reading session, the first client device also optionally performs (716) one or more of the following operations (e.g., 718-744).

In some embodiments, the first client device detects (718), based on the speech signal received from the first user, that the reading of the first reading unit is approaching completion. In response to detecting that the reading of the first reading unit is approaching completion, the first client device sends (720) a get-ready signal to the second client device, where the get-ready signal causes a get-ready prompt to be displayed at the respective start location of the second reading unit currently displayed at the second client device. For example, in FIG. 6B, when the client device 604 detects that Alice has finished reading ninety percent of the text in the first reading unit 518, the client device 604 sends a get-ready signal to the client device 606. The client device 606, upon receiving the get-ready signal from the client device 604, displays a get-ready prompt at the start location of the second reading unit 520 to prompt Max to get ready to read. In addition, after the second device 606 detects that Max has finished reading ninety percent of the text in the second reading unit 520, the second device 606 sends a get-ready signal to the third device 608. The client device 608, upon receiving the get-ready signal, displays a get-ready prompt to alert John to get ready to read. In some embodiments, the get-ready prompt is not necessarily displayed at the start of the reading unit to be read next. For example, in some embodiments, the get-ready prompt is merely a visual indicator (e.g., a blinking icon) to alert the next participant to get ready to start reading soon.

In some embodiments, the first reading prompt moves (722) through the first reading unit currently shown at the first client device in accordance with the progress of the reading by the first user.

In some embodiments, during the group reading session, the first client device processes (724) a speech signal received from the first user and evaluates the reading of the first user based on the speech signal. In some embodiments, the first client device detects (726) at least one reading error in the speech signal of the first participant in light of the first reading unit. In some embodiments, upon detecting the at least one reading error, the first client device displays (728) a first reading aid at a location of the reading error in the first reading unit currently shown at the first client device. For example, when the first client device detects a pronunciation error, a missed word, an added word, a misread word, an incorrect segmentation of a phrase or sentence, inappropriate reading speed, and/or incorrect emotion or prosody, etc., in the speech signal received from the first participant in light of the text in the first reading unit, the first client device displays a reading aid to help the first participant to correct the reading error. The reading aid include one or more of a phonetic spelling of the mispronunciation, highlighting of a missed word or mispronounced word, visual aids to indicate the correct emotion, prosody, segmentation, and/or speed of the reading through a phrase or passage, and so on.

In some embodiments, during the group reading session, the first client device, upon detecting the at least one reading error, sends (730) an error signal to the second client device (and one or more other client devices and/or the server). The error signal causes a visual indication of the reading error to be displayed at a location of the reading error in the first reading unit currently shown at the second client device (and the one or more other client devices and/or the server). In some embodiments, the number and types of error signals generated during each participant's reading are optionally used to evaluate the participant's reading ability level in one or more aspects, and to generate various reading ability scores for the participant.

In some embodiments, the group reading session is conducted in a read-aloud mode, in which each participant reads aloud the text of his/her assigned reading unit presented in front of him/her. In some embodiments, the group reading session is conducted in a recitation mode, in which each participant recites out loud the text of his/her assigned reading unit while the text is obfuscated in front of him/her. In some embodiments, some participants reads their respective assigned reading units in the read-aloud mode, while other participants reads their respective assigned reading units in the recitation mode. For example, in a group rehearsal, some actors/actresses may want to read their lines aloud with their scripts open in front of them, while other actors/actresses may wish to practice reciting their lines aloud without their scripts open in front of them.

Referring to FIGS. 7B-7C, in some embodiments, while both the first and the second client devices are in the read-aloud mode, the first reading prompt highlights (732) the first reading unit at the first user device and the second reading prompt highlights the second reading unit at the second user device. In some embodiments, when both the first and the second client devices are in the recitation mode, the first reading prompt visually obfuscates (734) the first reading unit at the first client device, and the second reading prompt visually obfuscates the second reading unit at the second client device. In some embodiments, when the first client device is in the read-aloud mode and the second client device is in the recitation mode, the first reading prompt highlights the first reading unit at the first client device, and the second reading prompt visually obfuscates the second reading unit at the second client device. In some embodiments, when the first client device is in the recitation mode and the second client device is in the read-aloud mode, the first reading prompt visually highlights the first reading unit at the first client device, and the second reading prompt visually obfuscates the second reading unit at the second client device.

In some embodiments, each participant is allowed to turn on the read-aloud mode or the recitation mode by providing a reading mode selection input his/her respective device. In some embodiments, the server optionally provides the respective reading mode selection input to each client device, and the user of the server device controls which participants will read in the read-aloud mode and which participants will read in the recitation mode.

In some embodiments, each reading unit is assigned a respective reading mode. If a particular reading unit is assigned a read-aloud mode, the reading prompt presented for the particular reading unit highlights the particular reading unit currently displayed at the respective client device of its assigned reader. If a particular reading unit is assigned a recitation mode, the reading prompt presented for the particular reading unit visually obfuscates the particular reading unit currently displayed at the respective client device of the assigned reader. In some embodiments, the mode of the reading is defined in the reading plan, e.g., by the creator of the reading plan using the reading plan generator interface.

In some embodiments, the first client device determines (736) a respective reading mode assigned to the reading of the first reading unit, the reading mode being one of a read-aloud mode and a recitation mode. In some embodiments, in accordance with a determination that the first reading unit is assigned the read-aloud mode, the first client device provides (738) the first reading prompt to highlight the first reading unit currently displayed at the first client device. In accordance with a determination that the first reading unit is assigned the recitation mode, the first client device provides (740) the first reading prompt to visually obfuscate the first reading unit currently displayed at the first client device.

In some embodiments, after the reading of the first reading unit has been completed by the first user, the first client device receives (742) a reading assessment summary for the reading of the first reading unit, the reading assessment summary identifying one or more areas needing improvement for the first user. In some embodiments, the first reading unit receives (744) a customized reading assignment for the first user according to the identified one or more areas needing improvement.

In some embodiments, the reading assessment summary also identifies one or more areas in which the first user has performed well, and is worthy of encouragement or commend. In some embodiments, the reading assessment summary is provided by the server device. In some embodiments, for each participant, the server device optionally receives comments from respective devices of other participants during the group reading session, and the server device optionally incorporates these comments into the reading assessment summary of the participant.

In some embodiments, after the group reading session, each client device is optionally used to monitor reading of the customized assignments by its respective user. In some embodiments, after the group reading session, the first client device receives (746) additional speech signals from the first user reading the customized reading assignment. In some embodiments, the first client device processes (e.g., using speech-to-text conversion and/or other means) (748) the additional speech signals to determine if the reading of the customized reading assignment is satisfactory. In some embodiments, the first client devices sends (750) a report to the server regarding the reading of the customized reading assignment by the first user.

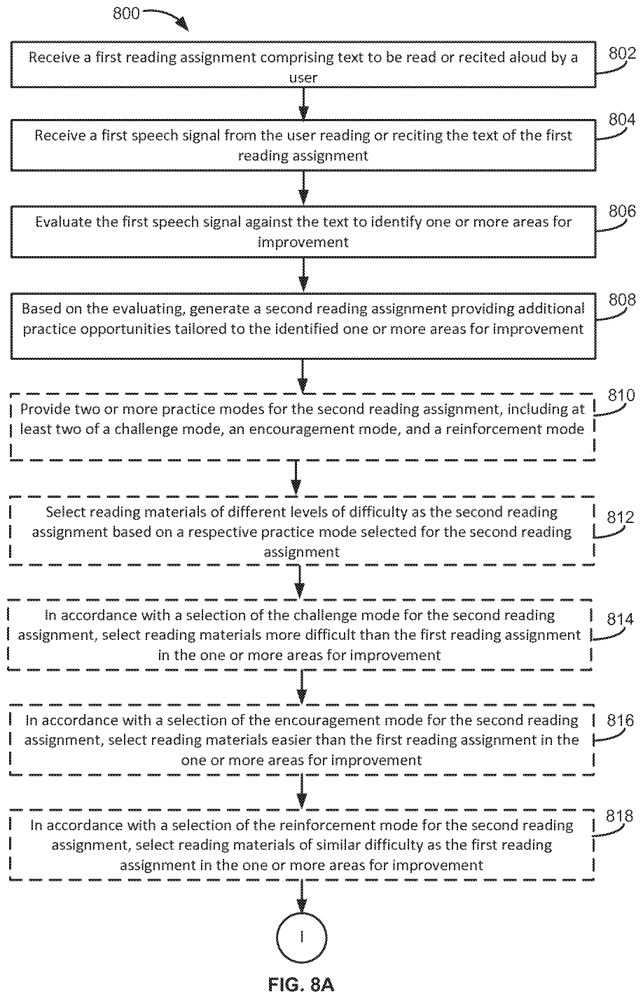

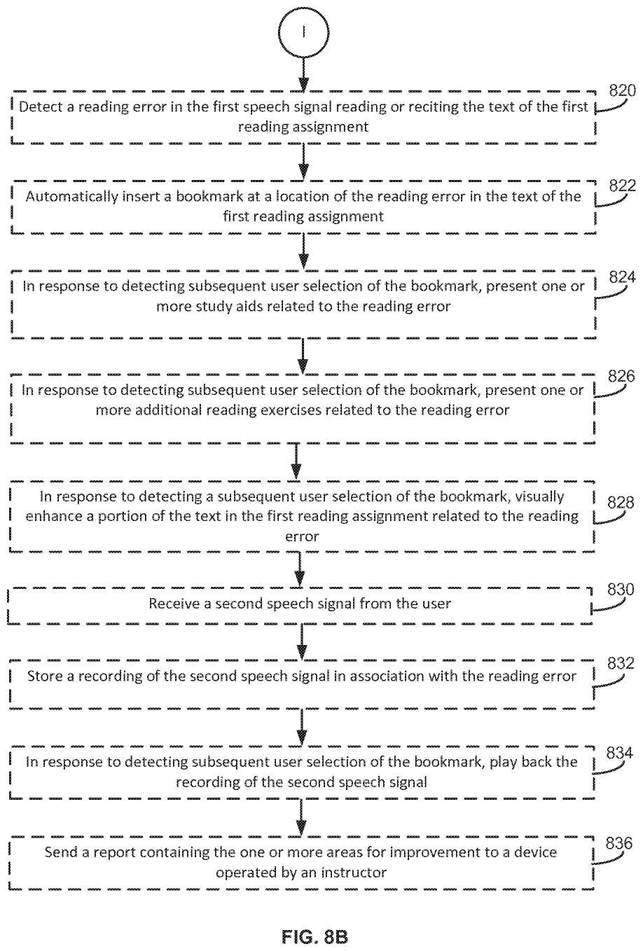

FIGS. 8A-8B is a flow chart of an exemplary process 800 for providing a customized reading assignment to a group reading participant. In some embodiments, the exemplary process 800 is optionally performed by a user device (e.g., a user device 300 or a user device 100) without its user first attending a group reading session. In other words, the user can read a reading assignment by him/herself and receive additional reading assignment based on how he/she has performed in her reading. In some embodiments, the exemplary process 800 is performed by a device operated by a user to whom the reading assignment has been assigned. In some embodiments, the exemplary process 800 is performed by a primary user device operated by an instructor of the user to whom the reading assignment has been assigned.

In the process 800, the user device receives (802) a first reading assignment comprising text to be read or recited aloud by a user. In some embodiments, the first reading assignment is a reading assignment received from a server device (e.g., an instructor's device) after a group reading session. In some embodiments, the first reading assignment is received from a server device without the user having participated in a group reading session. In some embodiments, the first reading assignment is selected by the user on the user device, e.g., according to his/her own interest or at the instruction of his/her instructor.

In some embodiments, if the first reading assignment is to be read aloud by the user, the user device displays the text of the first reading assignment to the user. In some embodiments, if the first reading assignment is to be recited by the user, the user device displays the text of the first reading assignment during a preparation period, and obfuscates the text or at least portions of the text after the preparation period has ended. In some embodiments, the user device selectively displays some text, and obfuscates other text in accordance with input received from the user.

In some embodiments, the user device receives (804) a first speech signal from the user reading or reciting the text of the first reading assignment. For example, in some embodiments, the user device captures the speech uttered directly by the user using a microphone coupled to the user device. In some embodiments, the user device (e.g., an instructor's device or a server device) receives the first speech signal from another device (e.g., the user device operated by the user) that directly captures the speech uttered by the user. In some embodiments, the speech signal is a recording of the speech uttered by the user, and is sent to the user device at a later time. In some embodiments, the speech signal is received by the user device in real-time as the user is speaking.

In some embodiments, if the first reading assignment is for the user to read aloud, the user device highlights each respective portion or word in the text at the moment that the user reads that portion or word in the text. In some embodiments, the visual indication (e.g., underline, a bouncing ball icon) moves synchronously through the displayed text, as the user reads through the text aloud. In some embodiments, if the reading stops at a particular location in the text for more than a predetermined amount of time (e.g., 2 seconds), the user device automatically enters a bookmark at that location in the text. In some embodiments, the user device optionally receives and stores textual input or other annotative inputs (e.g., drag and drop of photos, documents, notes, web pages, hyperlinks, etc.) in association with the bookmark inserted at that particular location.

In some embodiments, the user device processes the speech signal against the text in the first reading assignment, and provides a first type of visual enhancement (e.g., highlighting, bolding, or changing text or background color) for correctly pronounced words. In some embodiments, the user device processes the speech signal against the text in the first reading assignment, and provides a second type of visual enhancement (e.g., highlighting, bolding, or changing text or background color) for incorrectly pronounced words. In some embodiments, the user device detects one or more missed words in the speech signal, and provides a third type of visual enhancement for the missed words. In some embodiments, the user device detects one or more added words in the speech signal, and provides a fourth type of visual enhancement for the portion of text in which the extraneous words have been added.

In some embodiments, the user device detects extraneous fillers (e.g., empty, extraneous sounds or words that pad a sentence without adding any additional meaning, such as “I mean,” “sort of,” “ya know?” “well,” “umm,” “uh,” “like,” and equivalents in other languages) in the speech signal, and displays a visual alert for the user each time the filler is detected in real-time as the user is speaking. In some embodiments, the user device monitors the speed by which the text is read aloud, and displays a visual indicator for the user to slow down or speed up based on the actual speed by which the text is being read aloud by the user.

In some embodiments, the user device monitors the progress of the reading, and provides visual prompts to the user to change the intonation and/or emotion of the reading in real-time. For example, if the reading assignment is a script for a play, the reading assignment optionally associates respective predetermined emotions, accents, voice quality, and/or intonations with different portions of the text. In some embodiments, the user device optionally provides prompts (e.g., visual indicators or pop-up notes) for the desired emotions, accents, voice quality, and/or intonations associated with a particular portion of text, e.g., at a location proximate to the particular portion of text, and/or as the reading has almost reached that portion of the text.

In some embodiments, the user device evaluates (806) the first speech signal against the text of the first reading assignment to identify one or more areas for improvement. For example, the first reading assignment is optionally associated with various standards for pronunciation, accents, speed, intonation, emotion, voice quality, fidelity to the text, loudness, and/or pitch, etc., for various portions or the entirety of the text in the first reading assignment. In some embodiments, the user device evaluates the first speech signal against the text for one or more of these various standards.

In some embodiments, if the user's speech signal meets or exceeds the standards established for a number of required aspects, the user device displays a visual indication of successful completion of the reading assignment by the user. In some embodiments, if the user's speech signal does not meet the standard(s) established for one or more required aspects, the user device identifies these aspects as respective areas for improvement. For example, if the user has mispronounced a particular word, or a particular category of words (e.g., words containing the letters “th,” or words containing a silent “e” or “p,” or words containing accented letters, etc.), the user device identifies pronunciation of the particular word or particular category of words as an area for improvement. In another example, if the user has read one or more portions of the first reading assignment faster or slower than the standard established for all or some portions of the text, the user device identifies the reading speed or familiarity with the text as an area for improvement. In some embodiments, if the user has read one or more portions of the first reading assignment with an emotion or voice quality different from the standard established for those portions of the text, the user device identifies the emotion or voice quality as an area for improvement for those portions. In some embodiments, if the user has spoken more filler words or had inappropriate pauses during the reading or recitation of the first reading assignment than the standard established for fillers and pauses, the user device identifies the use of fillers and pauses as an area for improvement. Other examples of the areas for improvements are possible.

In some embodiments, based on the evaluating, the user device generates (808) a second reading assignment providing additional practice opportunities tailored to the identified one or more areas for improvement. For example, if the identified area for improvement is the pronunciation of a particular word or category of words, the user device optionally generates a second reading assignment containing drills and reading exercises containing that particular word or category of words, but differing from the text in the first reading assignment. For example, if the user has trouble pronouncing the word “these” and “those” in the first reading assignment, the user device generates more textual drills containing the words “these” and “those” in different sentences. In another example, the user device generates more textual drills containing other words containing the letters “th.”

In some embodiments, if the identified area for improvement is the speed by which the user has read one or more portions of the first reading assignment, the user device optionally generates a second reading assignment that is longer or shorter than the first assignment. For example, if the user is practicing a timed public speech based on the first reading assignment and is speaking too fast, the user device optionally generates a second reading assignment that removes some non-essential content of first reading assignment. When the user reads the second reading assignment under timed conditions, the user would feel the pressure to slow down for fear of the awkward silence at the end. Once the user has gained a feel of the slower reading speed, the user can practice reading the first reading assignment again at the newly achieved slower speed. In contrast, if the user is practicing a timed public speech based on the first reading assignment and is speaking too slowly; the user device optionally generates a second reading assignment that expands the content of the first reading assignment. When the user reads the second reading assignment under timed conditions, the user would feel the pressure to speed up for fear of not finishing on time. Once the user has gained a feel of the faster reading speed, the user can practice reading the first reading assignment again at the newly achieved faster speed. In some embodiments, the user device evaluates the user's reading speed of the second reading assignment as the reader practice reading the second reading assignment one or more times, and determines when it is appropriate to have the user read the first assignment again.

In some embodiments, if the user device identifies the emotion conveyed in the user's voice as an area for improvement for particular portions of the first reading assignment, the user device generates a second reading assignment containing one or more additional passages having similar emotional content or requiring similar voice quality as the portion of the first reading assignment for which the emotion was inappropriate or lacking.

In some embodiments, if the user device identifies the accent of the user's reading is an area for improvement, the user device generates a second reading assignment containing one or more additional passages having words reflective of the required accent and/or passages conveying a stereotypical impression of the required accent. For example, if the first assignment is to be read with an Italian accent and a tough edge, and the second reading assignment is optionally the transcript of a dialogue from a famous movie (e.g., the Godfather) depicting tough Italian mafia characters.

In some embodiments, if the user device has identified the excessive use of filler words and pauses in the reading of the first reading assignment as an area for improvement, the user device optionally identifies a pattern in the occurrence of the fillers and pauses in the reading or recitation, and generates a second reading assignment that provides visual aid to help the user to read through the text without conforming to that pattern. For example, at locations that the user is likely to insert a filler word, the user device optionally insert a visual aid (e.g., visually reducing the spacing between two consecutive words in the text) encouraging the user to speak continuously without using a filler word or pause. In some embodiments, the user device optionally displays the filler word in the text of the second assignment at the location that the user is likely to insert the filler word, such that the user can consciously replace the filler word in his/her reading of the text with a short pause instead. In some embodiments, the user device determines that the presence of filler words or pauses indicates unfamiliarity to the text of the first reading assignment, and generates a second reading assignment that provides additional notes regarding the portions of text at which the filler words and pauses were spoken by the user.

In some embodiments, the user device provides (810) two or more practice modes for the second reading assignment, including at least two of a challenge mode, an encouragement mode, and a reinforcement mode. In some embodiments, the user device selects (812) reading materials of different levels of difficulty as the second reading assignment based on a respective practice mode selected for the second reading assignment.

In some embodiments, in accordance with a selection of the challenge mode for the second reading assignment, the user device selects reading materials that are more difficult than the first reading assignment in the identified one or more areas for improvement. In some embodiments, in accordance with a selection of the encouragement mode for the second reading assignment, the user device selects reading materials that are easier than the first reading assignment in the identified one or more areas for improvement. In some embodiments, in accordance with a selection of the reinforcement mode for the second reading assignment, the user device selects reading materials that are of similar difficulty as the first reading assignment in the identified one or more areas of improvement.

In some embodiments, the instructor of the user optionally pre-selects the practice mode for the second reading assignment based on the identity of the user. In some embodiments, the user device automatically chooses the practice mode based on the user's performance in reading the first assignment. In some embodiments, if the user has performed fairly well in all aspects (though not perfectly), the user device automatically uses the challenge mode for the second reading assignment. In some embodiments, if the user has performed poorly in all aspects, the user device automatically uses the encouragement mode for the second reading assignment. In some embodiments, if the user has shown mixed performance in some aspects, the user device automatically selects the reinforcement mode for the second reading assignment.

In some embodiments, the user device detects (820) detects a reading error in the first speech signal reading or reciting the text of the first reading assignment. In some embodiments, in response to detecting the reading error, the user device automatically inserts (822) a bookmark at a location of the reading error in the text of the first reading assignment. In some embodiments, the user device displays all the bookmarks inserted into the text in the same user interface (e.g., a bookmark page) after the user's reading of the first reading assignment, such that the user can selectively review one or more of the reading errors at a later time.

In some embodiments, in response to detecting subsequent user selection of the bookmark (e.g., from the text of the first reading assignment currently shown on the user device, or from a bookmark page showing multiple reading error bookmarks), the user device presents (824) one or more study aids related to the reading error. In some embodiments, the study aids include one or more flash cards and/or notes showing the definitions, pronunciations, emotions, speed, accents, and/or prosody, etc. required for reading the portion of text at which the reading error had previously occurred. In some embodiments, the study aids include one or more recordings or demos of the correct reading.

In some embodiments, in response to detecting subsequent user selection of the bookmark, the user device presents (826) one or more additional reading exercises related to the reading error. For example, if the reading error is a pronunciation error of a particular word, selection of the bookmark optionally causes the correct pronunciation to be presented (e.g., played back as an audio clip, or shown as phoneme symbols) to the user.

In some embodiments, in response to detecting subsequent user selection of the bookmark, the user device visually enhances (e.g., highlights, bolds, animates, etc.) (828) a portion of the text in the first reading assignment that is related to the reading error. For example, if the user selects the bookmark for a particular reading error in the bookmark page, the user device displays a portion of the text from the first reading assignment that contains the location of the reading error, and visually highlights the text involved in the reading error.

In some embodiments, the user device receives (830) a second speech signal from the user. The user device stores (832) a recording of the second speech signal in association with the reading error. In response to detecting subsequent user selection of the bookmark, the user device plays back (834) the recording of the second speech signal. For example, after detecting a particular reading error in the user's reading of the first reading assignment, the user device generates a bookmark for the reading error, and allows the user to record a personal note for the reading error. Sometimes, the user may wish to record a personal node that is tailored to the user's particular pronunciation habit, or understanding of the text. Sometimes, the user may simply wish to record her best attempt at producing a satisfactory reading for this portion of the text after practicing and reading the study aids. This is a useful option for the user to distill the study aid information that has shown to the user and the multiple practices the user has performed into a few key points in the user's own words, so that the user does not have to review all of the study aid information again in the future. In some embodiments, the user device presents a user interface element (e.g., a record personal node button) in the bookmark interface to start the recording of the second speech signal (e.g., a personal note).

In some embodiments, the user device sends (836) a report containing the one or more areas for improvement to a device operated by an instructor of the user. In some embodiments, the report optionally also contains the one or more reading errors made by the user.

In some embodiments, in addition to providing reading assignments to the user and evaluating the reading/recitation by the user, the user device also presents other types of assignments and questions to the user, and allows the user to provide answers in speech form. For example, after the reading or recitation of the first reading assignment, the user device optionally presents questions about the text in the first reading assignment, and checks on the user's comprehension of the text.

In some embodiments, the user device incorporates one or more multiple choice or short answer questions in an assignment, and the user device captures speech input from the user answering the multiple choice or short answer questions. Based on the speech input received from the user, the user device optionally determines whether the user has provided the correct answers to the multiple choice or short answer questions. Speech-to-text processing in these embodiments is relatively easy, since only a limited corpus of text (e.g., a corpus containing the letter choices for the multiple choice questions and/or correct answers to the short answer questions) need to be used to perform the speech recognition. In some embodiments, the user device automatically grades the user's answers, and sends the grade report to the instructor. In some embodiments, the user device also stores and send a recording of the user's answers to the instructor, e.g., for future evaluation and/or verification purposes.

In some embodiments, the user device provides additional notes, links, and annotations in the answers, and the user can review these additional notes, links, and annotations when reviewing the answers to the multiple choices and/or short answer questions. In some embodiments, selection of the links by the user causes the user device to display a portion of a text book or a portion of the first reading assignment that shows the correct answer.

Features described with respect to FIGS. 7A-7D and 8A-8B are optionally combined with one or more features described with respect to FIGS. 4A-4F, 5A-5B, and 6A-6B, in accordance with various embodiments.

Sometimes, a collaborative reading environment includes two or more participants in which a first participant has a more active role as compared to a second participant. For example, sometimes, a parent may read the text of a story to a child, while the child looks at a graphical illustration of the text that the parent is reading. Sometimes, the parent may read a more difficult portion of the story to the child, and let the child read a short and simple portion of the story back to the parent. Sometimes, two children may take turns reading aloud parts of a story, while each child is given an opportunity to change one or more aspects of the story (e.g., plot, characters, objects, location, time, etc.) while reading his/her part.

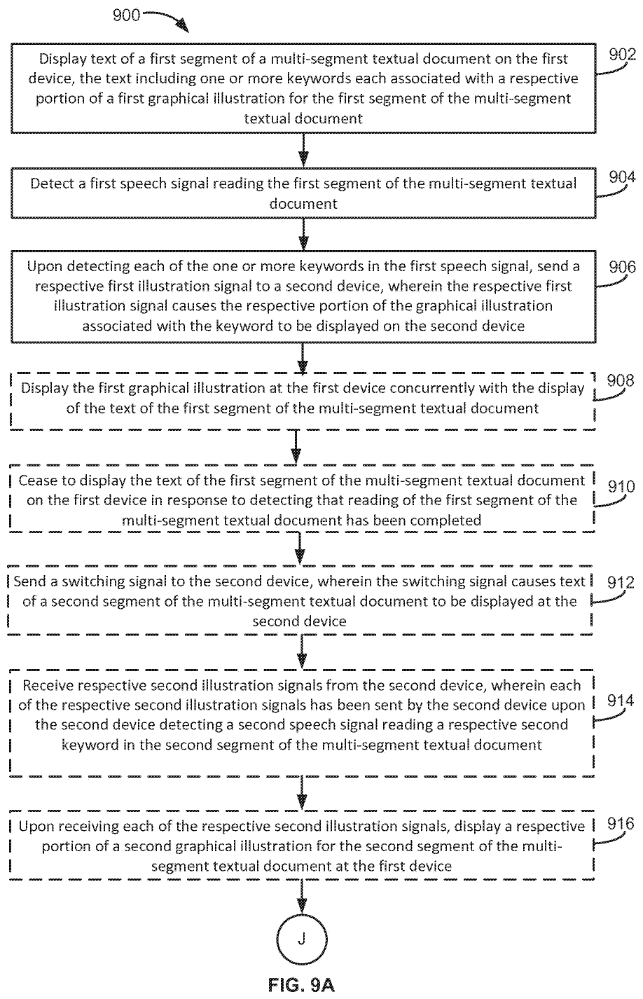

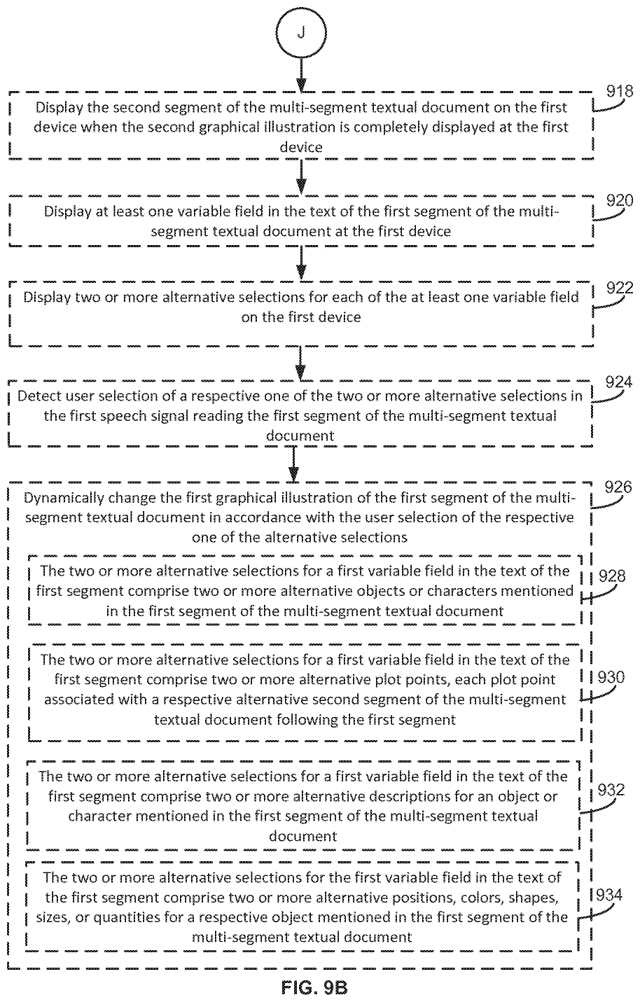

FIG. 9 is a flow chart illustrating an exemplary process 900 for facilitating a collaborative reading session in accordance with one or more of the above scenarios or other suitable scenarios. In some embodiments, the exemplary process 900 is performed by a user device (e.g., a user device 300 or a user device 100) operated by a first participant of the collaborative reading session. The user device operated by the first participant of the collaborative reading session communicates with another user device (e.g., another user device 300 or another user device 100) operated by a second participant of the collaborative reading session. Although the process 900 is described with respect to only two participants of the collaborative reading session, it is understood that more than two participants operating their respective devices may participant in the collaborative reading session, and each device may serve as the first user device, while another user device serves as the second user device described in the exemplary process 900.

In the exemplary process 900, at a first device having one or more processors, memory, and a display, the first device displays (902) text of a first segment of a multi-segment textual document on the display of the first device. In some embodiments, the multi-segment textual document is one of a story, an article, a chapter in a textbook, a news article, the script of a play, and/or other document comprising passages of text that can be read aloud by a user. In some embodiments, the multiple segments of the textual document are based on natural divisions (e.g., sentences, chapters, sections, roles, sub-headings, etc.) that are present in the textual document. In some embodiments, the multiple segments are generated manually by a user, an editor or publisher of the textual document, or automatically by a software segmentation process.

In some embodiments, each segment of the multi-segment textual document is associated with one or more graphical illustrations. For example, in some embodiments, each scene of a story is associated with a respective graphical illustration depicting that scene. In another example, each section of an article is optionally associated with a respective diagram or figure illustrating the key content of the section. In yet another example, an article describing a process (e.g., an oil refining process) optionally includes respective text segments describing each of multiple stages of the process, and each stage is associated with a respective step shown in a flow diagram of the process.

In some embodiments, the text of the first segment of the multi-segment textual document includes one or more keywords each associated with a respective portion of a first graphical illustration for the first segment of the multi-segment textual document.

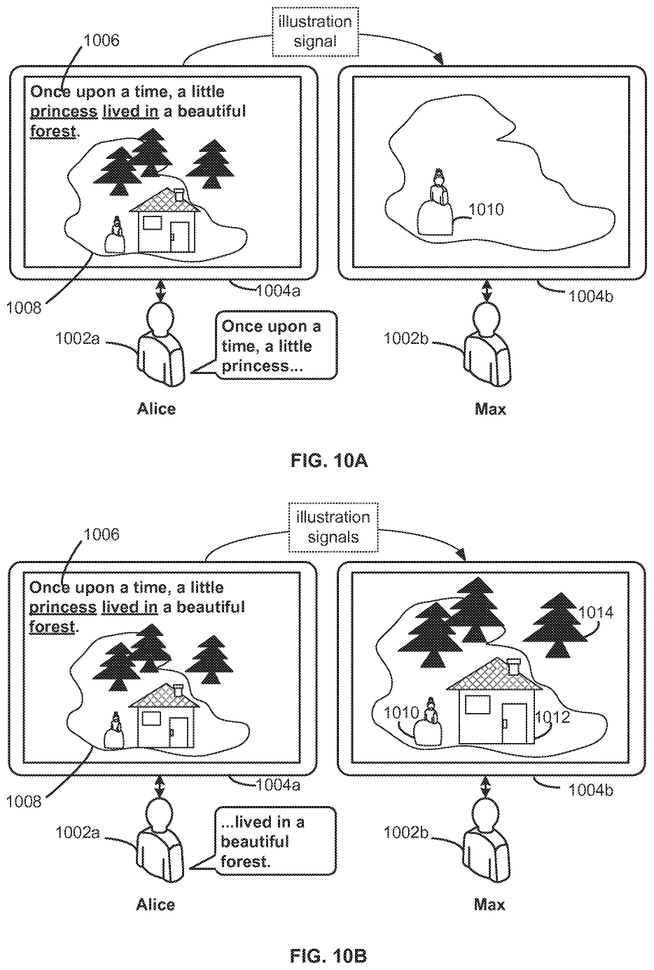

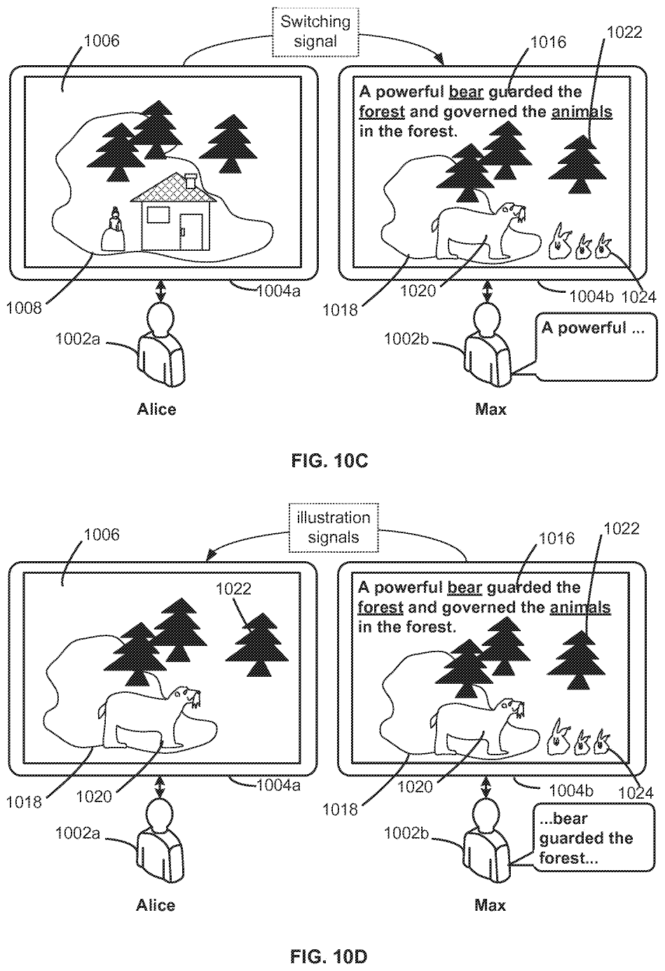

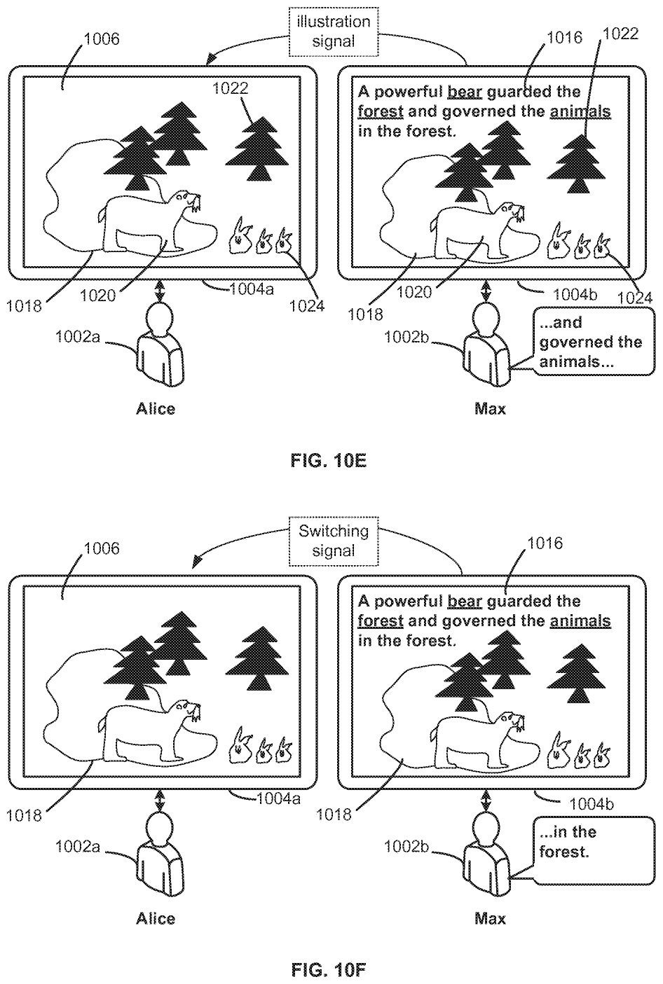

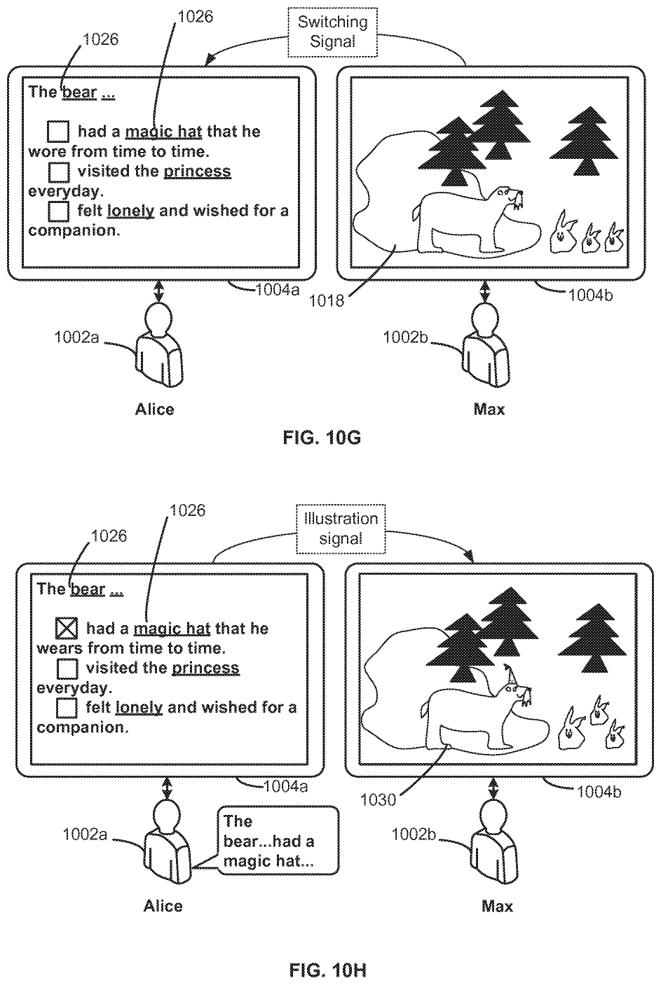

As a particular example, as shown in FIG. 10A, two participants 1002a and 1002b (e.g., Alice and Max) are participating in a collaborative reading session. Alice is operating a first user device 1004a, while Max is operating a second user device 1004b. On Alice's device 1004a, text 1006 of a first segment (e.g., a first sentence, a first paragraph, or an opening scene) of a textual document (e.g., a story) is displayed. In some embodiments, a graphical illustration 1008 of the first segment is displayed on Alice's device 1004a as well. In some embodiments, the device 1004a optionally displays only the text 1006 and not the illustration 1008. In some embodiments, before the reading of the first segment 1006 is started, the text 1006 and the illustration 1008 are not shown on the other participant's device 1004b. In some embodiments, the device 1004b displays the text 1006 but not the illustration 1008 before the reading of the text 1006 is started.

As shown in FIG. 10A, the first segment of text 1006 includes three keywords (e.g., “princess,” “lived in,” and “forest”), and each of the keywords is associated with a respective portion of the first graphical illustration 1008. For example, the keyword “princess” is associated with the princess figure in the illustration 1008, the keyword “forest” is associated with the trees in the illustration 1008, while the keyword “lived in” is associated with the little house shown in the illustration 1008. In some embodiments, the keywords do not necessarily refer to static objects, e.g., keywords are not necessarily nouns or pronouns. In some embodiments, the keywords also include strings or words representing actions (e.g., verbs), positions, spatial and temporal relations (e.g., prepositions), emotions and manners of actions (e.g., adverbs), appearance (e.g., adjectives), etc. In some embodiments, the keywords are highlighted in the text 1006 displayed on the first device 1004a, as shown in FIG. 10A. In some embodiments, the keywords are not visually enhanced as compared to other portions of the first segment of text.

Referring back to FIG. 9A, after the text of the first segment of the multi-segment textual document has been displayed at the first device, the first device detects (904) a first speech signal reading the first segment of the multi-segment textual document. In some embodiments, upon detecting each of the one or more keywords in the first speech signal, the first device sends (906) a respective first illustration signal to a second device, where the respective illustration signal causes the respective portion of the graphical illustration associated with the keyword to be displayed at the second device.

In some embodiments, the first device displays (908) the first graphical illustration on the first device concurrently with the display of the text of the first segment of the multi-segment textual document. In some embodiments, the first device displays each portion of the first graphical illustration upon detecting the keyword associated with the portion of the first graphical illustration in the speech signal. In other words, in some embodiments, the first device shows the complete graphical illustration for the first segment of the textual document while the text is displayed on the first device. In some embodiments, the first device gradually completes the graphical illustration for the first segment of the textual document, as the user reads through the text of the first segment.

As illustrated in the particular example shown in FIG. 10A, as the first user 1002a (e.g., Alice) reads the first segment of text 1006 aloud, the user device captures the speech signal from the first user 1002a. The first device processes the speech signal against the first segment of text 1006, and determines whether the keywords in the text 1006 have been spoken by the user 1002a. As soon as a particular keyword (e.g., “princess”) is detected in the user's speech signal, the first device 1004a sends an illustration signal to the second device 1004b operated by the second user 1002b (e.g., Max), and the signal causes the second device 1004b to display a portion 1010 (e.g., the princess figure) of the first illustration 1008 that is associated with the detected keyword (e.g., “princess”).

In some embodiments, not shown in FIG. 10A, if the first device has not displayed the first illustration 1008 with the text 1006, detection of the particular keyword (e.g., “princess”) by the first device 1004a also causes the portion of the first graphical illustration 1008 associated with the particular keyword to be displayed on the first user device 1004a. In some embodiments, as the text 1006 of the first segment is read aloud by the first user 1002a (e.g., Alice), the text is gradually (e.g., word by word) displayed on the second device 1004b as well. In some embodiments, the keyword that causes each portion of the first graphical illustration to be displayed on the second device is highlighted on the second device 1004b when the corresponding portion of the illustration is displayed on the second device 1004b.

As shown in FIG. 10B, as the first user 1002a (e.g., Alice) continues to read the text of the first segment 1006 aloud, another two keywords (e.g., “lived in” and “forest”) are detected consecutively in the speech signal from the first user 1002a. In response to detecting each of the two keywords, the first device sends a respective illustration signal to the second device 1004b, and the respective signals cause two more portions (e.g., a little house 1012 and trees 1014) of the first graphical illustration 1008 to be displayed on the second device 1004b.

In some embodiments, the individual portions (e.g., the princess FIG. 1010, the little house 1012, and the trees 1014) of the first graphical illustration 1008 are composed into the first graphical illustration 1008 when they are all displayed on the second device 1004b. In some embodiments, each additional portion of the first graphical illustration displayed on the second user device 1004b optionally causes previous portions already displayed on the second device 1004b to change, such that all of the portions currently displayed on the second device form a cohesive illustration. For example, when the little house 1012 is displayed on the second device 1002b, the princess FIG. 1010 initially displayed on the second device 1002b optionally moves toward the little house 1012, and opens a door on the little house 1012. In some embodiments, the first graphical illustration or a partially completed version thereof includes animated parts (e.g., the princess FIG. 1010 optionally waves her hand at the user from time to time, or a little bird lands on the little house 1012 after the house 1012 is displayed).

In some embodiments, the device 1004a and the device 1004b are not located in vicinity of each other, and the device 1004a and the device 1004b communicate with each other remotely through one or more networks (e.g., the Internet). In some embodiments, when the device 1004a and the device 1004b are located in vicinity of each other, the second device 1004b optionally captures and processes the speech signal from the first user directly. In such embodiments, when the second device 1004b detects, in the speech signal from the first user, each of the one or more keywords in the text 1006 of the first segment, the second device 1004b displays the corresponding portion of the first graphical illustration 1008 on the second device 1004b without requiring the illustration signal to be sent from the first user device 1004a.

In some embodiments, after the reading of the first segment has been completed by the first user (e.g., Alice), the first device continues to display text of a second segment of the multi-segment textual document that follows the first segment. For example, in some collaborative reading sessions, the first participant (e.g., Alice) optionally reads all or multiple consecutive portions of the textual document before passing the reading control to another participant (e.g., Max). In some embodiments, the display of the second segment optionally replaces the display of the first segment on the first device, when the text of the second segment is displayed on the first device. In some embodiments, when the second segment is displayed on the first device, a second graphical illustration associated with the second segment is displayed on the first device. In some embodiments, the second graphical illustration replaces the first graphical illustration on the first device. In some embodiments, an animation is presented on the first device showing the transformation from the first graphical illustration into the second graphical illustration, when the text of the second segment is displayed on the first device.

In some embodiments, after reading of one or more segments (including the first segment) is completed by the first user 1002a, the first user 1002a optionally passes the reading control to the second user 1002b. In some embodiments, the first user 1002a decides when to pass the reading control to the second user 1002b, e.g., by providing a manual switching input to the first device 1002a. For example, a manual switching input includes a user selection of a predetermined user interface element (e.g., a “switch” button) provided on the first device 1002a. In some embodiments, the first user 1002a optionally brings the first device 1002a close to or in contact with the second device 1002b to cause a switch input to be entered at both the first device 1002a and the second device 1002b. The switch input entered at the first device 1002a causes the first device to relinquish the reading control to the second device, and the switch input entered at the second device 1002b causes the second device to accept the reading control from the first device.

In some embodiments, locations for switching reading control have been predetermined and specified in the first user device (e.g., in a predetermined reading plan). In such embodiments, when the first device processes the speech signal from the first user and determines that the reading has reached a switching location (e.g., the end of the first segment) in the textual document, the first device automatically generates the switch signal and sends the switch signal to the second device to pass the reading control to the second device.

Referring back to FIG. 9A, in some embodiments, the first device ceases (910) to display the text of the first segment of the multi-segment textual document on the first device in response to detecting that reading of the first segment has been completed. In some embodiments, the first device does not cease to display the text of the first segment, if there is sufficient display space to show both the text of the first segment and additional content (e.g., the text of other segments and graphical illustrations) associated with the textual document on the first device. In some embodiments, the first device sends (912) a switching signal to the second device, where the switching signal causes text of the second segment of the multi-segment textual document to be displayed at the second device. When the second device receives the switching signal, the second device now gains the reading control, and causes subsequent illustration to be displayed on the first device.

In some embodiments, after the first device has sent the switching signal to the second device, the first device assumes a passive role in the collaborative reading session, and waits for illustration signals from the second device. In some embodiments, the first device receives (914) respective second illustration signals from the second device, where each of the respective second illustration signals has been sent by the second device upon the second device detecting a second speech signal reading a respective second keyword in the second segment of the multi-segment textual document. In some embodiments, upon receiving each of the respective second signals, the first device displays (916) a respective portion of a second graphical illustration for the second segment of the multi-segment textual document on the display of the first device. In some embodiments, the first device displays (918) the second segment of the multi-segment textual document on the first device when the second graphical illustration is completely displayed on the first device.

Referring now to the particular example illustrated in FIG. 10C, the first user 1002a has finished reading of the text 1006 of the first segment, and the first device 1004a has send a switch signal to the second device 1004b. In some embodiments, the text 1006 of the first segment is optionally removed from the first device 1002a. In some embodiments, the first graphical illustration 1008 optionally remains on the first device 1002a. In some embodiments, the second device 1004b, upon receiving the switch signal, displays text 1016 of the second segment of the multi-segment textual document. For example, the second segment 1016 is a second sentence immediately following a first sentence previously shown on the first device 1002a. In some embodiments, the second device 1004b also displays the second graphical illustration 1018 associated with the second segment of text 1016. In this example, the second segment of text 1016 includes three keywords (e.g., “bear,” “forest,” and “animals”). Each of the three keywords is associated with a respective portion of the second graphical illustration. For example, the keyword “bear” is associated with the bear 1020 shown in the second graphical illustration 1018, the keyword “forest” is associated with the background forest 1022 shown in the second graphical illustration 1018, and the keyword “animals” is associated with the rabbits 1024 shown in the second graphical illustration 1018. In some embodiments, the second graphical illustration 1018 is an augmented version of the first graphical illustration 1008, and adds additional components to the first graphical illustration 1008. In some embodiments, the second graphical illustration 1018 is a new illustration replacing the first graphical illustration 1008 displayed on the devices 1004a-b.

As shown in FIG. 10D, the second reader 1002b has started reading the text of the second segment 1016 aloud while the text is displayed on the second device 1004b. In some embodiments, the keywords in the second segment 1016 are visually highlighted on the display of the second device 1004b. In some embodiments, the second device 1004b captures the speech signal from the second user (e.g., Max) and processes the speech signal against the second segment of text 1016. When the second device 1004b detects particular keyword(s) (e.g., “bear” and “forest”) in the speech signal, the second device 1004b sends respective illustration signal(s) to the first device 1004a. In response to the illustration signal(s) from the second device 1004b, the first device 1004a displays portion(s) (e.g., the bear 1020 and the forest background 1022) of the second graphical illustration 1018 that are associated with the detected keyword(s) (e.g., “bear” and “forest,” respectively) on its display.

As shown in FIG. 10E, as the second user 1002b continues to read the text of the second segment 1016, the second device 1004b detects one more keyword (e.g., “animals”) in the speech signal captured from the second user 1002b. Upon detection of the additional keyword, the second device 1004b sends a respective illustration signal to the first device 1004a. The first device 1004a displays the respective portion of the second graphical illustration 1018 (e.g., the rabbits 1024) upon receipt of the respective illustration signal. When all of the keywords have been read by the second user 1002b, the second graphical illustration 1018 is completely shown on the first device 1002a, as shown in FIG. 10E

As shown in FIG. 10F, after the second user 1002b has finished reading the second segment 1016 of the textual document, the second user enters a switching input into the second device 1002b and causes the second device 1002b to send a switching signal to the first device 1002a. When the first device 1002a receives the switching signal, the first device 1002a now has regained the reading control of the textual document. In some embodiments, the second graphical illustration 1018 remains on the first device 1002a until the switching signal has been received by the first device 1002a.

Referring back to FIG. 9B, in some embodiments, the textual document includes options to vary one or more aspects of the content in the textual document. For example, the textual document optionally includes multiple alternative plots that can be selected at one or more plot points. In another example, one or more aspects, such as the name and identities of characters, color and appearance of objects, locations, time, positions, relationships between objects and characters in the content of the textual document can be varied based on user input and/or selection.

In some embodiments, the first device displays (920) at least one variable field in the text of the first segment (or any segment) of the multi-segment textual document currently displayed on the first device. In some embodiments, the first device also displays (922) two or more alternative selections for each of the at least one variable field on the first device. In some embodiments, the first device also allows freeform input from the user regarding the value of at least one of the variable fields. In some embodiments, the first device detects (924) user selection of a respective one of the two or more alternative selections in the first speech signal reading the first segment of the multi-segment textual document.

In some embodiments, the first device dynamically changes (926) the first graphical illustration of the first segment in accordance with the user selection of the respective one of the alternative selections. For example, in some embodiments, the first device stores a respective graphical illustration for the first segment in association with each alternative selection of the variable field. Before determining which portion of the first graphical illustration is displayed on the second device upon detection of a keyword, the first device generates or selects a particular graphical illustration that is associated with the selected alternative as the first graphical illustration for the first segment. In some embodiments, the first device stores a template illustration for the first segment, and upon selection of a particular alternative for the variable field, the first device dynamically generates the first graphical illustration for the first segment based on the template illustration and the selected alternative for the variable field.

As illustrated in a particular example shown in FIGS. 10G-10H, the first device 1004a has regained the reading control of the textual document. For clarity and ease of description, a different segment of text 1026 is shown on the user device 1004a. The segment of text 1026 includes a variable field for a new plot at a plot point in the segment of text 1026. The different options for the new plots are presented on the first device 1002a. As the first user reads through the segment of text 1026 and reaches the plot point (e.g., the location after the words “the bear”) in the text 1026, the first user chooses one of the three displayed options 1028 (e.g., (1) “had a magic hat that he wore from time to time;” (2) “visited the princess everyday;” and (3) “felt lonely and wished for a companion.”) for the new plot by reading the text contained in that option. In this example, the first user 1002a has chosen to continue with plot option (1) (e.g., “the bear had a magic hat that he wore from time to time”). The first device 1002a, upon detecting that the user (e.g., Alice) has chosen the first option based on the speech signal captured from the first user, generates a graphical illustration 1030 based on the selected plot option. In some embodiments, keywords contained in the selected option are detected, and the graphical illustration 1030 is displayed gradually on the second device 1002b in response to the keywords being uttered by the first user. For example, a keyword “magic hat” is contained in the selected option, and when the first user uttered the word “magic hat,” an illustration signal is sent from the first device 1002a to the second device 1002b. The second device 1002b, upon receiving the illustration signal from the first device 1002a, displays a little wizard's hat over the head of the bear figure in the illustration 1030.

In some embodiments, instead of choosing the plot option herself, the first user (e.g., Alice) optionally allows the second user (e.g., Max) to choose the plot options. For example, the first user optionally enters a switching input after the first user's reading has reached the plot point (e.g., after the words “the bear”) in the text 1026. In some embodiments, the switching input causes the options to be presented on the second user device 1004b. Once the second user has selected the plot option by reading one of the options presented or selecting using another type of selection input (e.g., touch or mouse input), the second user device 1004b returns the reading control back to the first user device 1004a, e.g., in response to another switching input entered by the second user.

Referring back to FIG. 9B, in some embodiments, the two or more alternative selections for a first variable field in the text of the first segment include (928) two or more alternative objects or characters mentioned in the first segment of the multi-segment textual document. For example, instead of a “bear,” the first segment may include options such as “lion” or “deer” in addition to the “bear” character for user selection. Selection of the different options would cause the graphical illustration to change accordingly as well.

In some embodiments, the two or more alternative selections for a first variable field in the text of the first segment include (930) two or more alternative plot points, each plot point is associated with a respective alternative subsequent segment (e.g., second segment) of the multi-segment textual document following the first segment. An example of these embodiments is shown in FIGS. 10G-10H.

In some embodiments, the two or more alternative selections for a first variable field in the text of the first segment include (932) two or more alternative descriptions for an object or character mentioned in the first segment of the multi-segment textual document. For example, instead of a “white-bearded bear,” the first segment may include options such as “brown bear” or “giant bear” in addition to the “white-bearded bear” option for user selection. Selection of the different options would cause the graphical illustration to change accordingly as well.

In some embodiments, the two or more alternative selections for the first variable field in the text of the first segment include (934) two or more alternative positions, colors, shapes, sizes, textures, quantities, transparencies, material states, physical properties, and/or emotional states, etc., for a respective object or character mentioned in the first segment of the multi-segment of the multi-segment textual document. Other alternative options and combinations thereof are also possible.

Features described with respect to FIGS. 9A-9B and 10A-10H are optionally combined with one or more features described with respect to FIGS. 4A-4F, 5A-5B, 6A-6B, and 8A-8B, in accordance with various embodiments.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. (canceled)

2. A system, comprising:
one or more processors; and
memory including instructions stored thereon, the instructions, when executed by one or more processors, cause the processors to perform operations comprising:
receiving a first reading assignment comprising text to be read or recited aloud by a user;
receiving a first speech signal from the user reading or reciting the text of the first reading assignment;
evaluating the first speech signal against the text to identify one or more areas for improvement; and
based on the evaluating, generating a second reading assignment providing additional practice opportunities tailored to the one or more areas for improvement.

3. The system of claim 2, further including instructions that when executed by the one or more processors, cause the processors to perform operations comprising:
providing two or more practice modes for the second reading assignment, including at least two of a challenge mode, an encouragement mode, and a reinforcement mode; and
selecting reading materials of difference levels of difficulty as the second reading assignment based on a respective practice mode selected for the second reading assignment.

4. The system of claim 3, further including instructions that when executed by the one or more processors, cause the processors to perform operations comprising:
in accordance with a selection of the challenge mode for the second reading assignment, selecting reading materials that are more difficult than the first reading assignment in the one or more areas for improvement;
in accordance with a selection of the encouragement mode for the second reading assignment, selecting reading materials that are easier than the first reading assignment in the one or more areas for improvement; and
in accordance with a selection of the reinforcement mode for the second reading assignment, selecting reading materials of similar difficulty as the first reading assignment in the one or more areas for improvement.

5. The system of claim 2, further including instructions that when executed by the one or more processors, cause the processors to perform operations comprising:
detecting a reading error in the first speech signal reading or reciting the text of the first reading assignment; and
automatically inserting a bookmark at a location of the reading error in the text of the first reading assignment.

6. The system of claim 5, further including instructions that when executed by the one or more processors, cause the processors to perform operations comprising:
in response to detecting subsequent user selection of the bookmark, presenting one or more study aids related to the reading error.

7. The system of claim 5, further including instructions that when executed by the one or more processors, cause the processors to perform operations comprising:
in response to detecting subsequent user selection of the bookmark, presenting one or more additional reading exercises related to the reading error.

8. The system of claim 5, further including instructions that when executed by the one or more processors, cause the processors to perform operations comprising:
in response to detecting a subsequent user selection of the bookmark, visually enhancing a portion of the text in the first reading assignment related to the reading error.

9. The system of claim 5, further including instructions that when executed by the one or more processors, cause the processors to perform operations comprising:
receiving a second speech signal from the user;
storing a recording of the second speech signal in association with the reading error; and
in response to detecting subsequent user selection of the bookmark, playing back the recording of the second speech signal.

10. The system of claim 5, further including instructions that when executed by the one or more processors, cause the processors to perform operations comprising:
sending a report containing the one or more areas for improvement to a device operated by an instructor.

11. A non-transitory computer-readable medium having instructions stored thereon, the instructions, when executed by one or more processors, cause the processors to perform operations comprising:
receiving a first reading assignment comprising text to be read or recited aloud by a user;
receiving a first speech signal from the user reading or reciting the text of the first reading assignment;
evaluating the first speech signal against the text to identify one or more areas for improvement; and
based on the evaluating, generating a second reading assignment providing additional practice opportunities tailored to the one or more areas for improvement.

12. A method, comprising:
at a device having one or more processors, memory, and a display:
receiving a first reading assignment comprising text to be read or recited aloud by a user;
receiving a first speech signal from the user reading or reciting the text of the first reading assignment;
evaluating the first speech signal against the text to identify one or more areas for improvement; and
based on the evaluating, generating a second reading assignment providing additional practice opportunities tailored to the one or more areas for improvement.
